(19) United States
(12) Patent Application Publication
(10) Pub. No.: US 2025/0095482 A1
(43) Pub. Date: Mar. 20, 2025

(54) DISPLAY APPARATUS AND NON-TRANSITORY COMPUTER-READABLE STORAGE MEDIUM STORING A COMPUTER PROGRAM

(71) Applicant: Sumitomo Electric Industries, Ltd., Osaka-shi, Osaka (JP)

(72) Inventors: Ryota MORINAKA, Osaka-shi, Osaka (JP); Kengo KISHIMOTO, Osaka-shi, Osaka (JP)

(73) Assignee: Sumitomo Electric Industries, Ltd., Osaka-shi, Osaka (JP)

(21) Appl. No.: 18/288,189

(22) PCT Filed: Mar. 10, 2022
(86) PCT No.: PCT/JP2022/010575

§ 371 Date: Oct. 25, 2023

(30) Foreign Application Priority Data
Apr. 28, 2021 (JP) 2021-076041

(51) Int. Cl. G08G 1/04

(52) U.S. Cl. CPC G08G 1/04

(57) ABSTRACT

A display apparatus includes a first result display portion configured to display a first traffic volume detected by an infrastructure sensor configured to detect vehicles in a measurement area, and a second result display portion configured to display reference information indicating a second traffic volume obtained by a means different from the infrastructure sensor during a same period as a period during which the infrastructure sensor detects the first traffic volume.

### TECHNICAL FIELD

The present disclosure relates to a display apparatus and a computer program. This application claims priority based on Japanese Patent Application No. 2021-076041 filed on Apr. 28, 2021, and the entire contents of the Japanese patent application are incorporated herein by reference.

### BACKGROUND ART

PTL 1 discloses an axis adjustment apparatus for performing axis adjustment of a vehicle-mounted radar mounted on a vehicle.

### CITATION LIST

### Patent Literature

PTL 1: Japanese Unexamined Patent Application Publication No. 2015-68746

### SUMMARY OF INVENTION

A display apparatus according to an aspect of the present disclosure includes a first result display portion configured to display a first traffic volume detected by an infrastructure sensor configured to detect vehicles in a measurement area, and a second result display portion configured to display reference information indicating a second traffic volume obtained by a means different from the infrastructure sensor during a same period as a period during which the infrastructure sensor detects the first traffic volume.

A computer program according to an aspect of the present disclosure is a computer program for causing a computer to execute: a process of displaying, on a display apparatus, a first traffic volume of vehicles detected by an infrastructure sensor configured to detect the vehicles in a measurement area, and a process of displaying, on the display apparatus, reference information indicating a second traffic volume obtained by a means different from the infrastructure sensor during a same period as a period during which the infrastructure sensor detects the first traffic volume.

The present disclosure can be achieved not only as a display apparatus including the characteristic configurations as described above, but also as a display method including the characteristic process of the display apparatus as steps, or as a computer program for causing a computer to execute the above method. The present disclosure can be achieved as a radar installation angle adjustment system including a display apparatus, or a part or all of the display apparatus can be achieved as a semiconductor integrated circuit.

### BRIEF DESCRIPTION OF THE DRAWINGS

FIG. 1 shows an example of a use of an infrastructure sensor in accordance with a first embodiment.

FIG. 2 is a perspective view showing an example of an appearance configuration of an infrastructure sensor according to the first embodiment.

FIG. 3 is a block diagram showing an example of a configuration of a radar setting apparatus according to the first embodiment.

FIG. 4 is a functional block diagram showing an example of a function of the radar setting apparatus according to the first embodiment.

FIG. 5A is a diagram showing an example of a setting screen according to the first embodiment.

FIG. 5B is a diagram showing an example of a setting screen on which basic data is input.

FIG. 5C is a diagram showing an example of a setting screen on which a lane shape line is drawn.

FIG. 5D is a diagram showing an example of a setting screen on which a mark point is input.

FIG. 5E is a diagram showing an example of a setting screen in an editing mode of a lane region.

FIG. 5F is a diagram showing an example of a setting screen on which a running trajectory of a vehicle is displayed.

FIG. 5G is a diagram showing an example of a setting screen after the position and the angle of a running trajectory have been adjusted.

FIG. 5H is a diagram showing an example of a setting screen displaying the number of vehicles for each of the lanes detected by an infrastructure sensor and the number of vehicles for each of the lanes input by a user.

FIG. 6A is a diagram for explaining an example of initial setting of a lane region in a coordinate space of a radar.

FIG. 6B is a diagram for explaining an example of setting of a lane region in a coordinate space of a radar.

FIG. 7 is a diagram showing an example of a save instruction portion.

FIG. 8 is a flowchart showing an example of a procedure of lane region setting process of a radar setting apparatus according to the first embodiment.

FIG. 9 is a flowchart showing an example of a procedure of detection accuracy confirmation process of a radar setting apparatus according to the first embodiment.

FIG. 10 is a diagram showing an example of a select portion.

FIG. 11 is a diagram showing an example of a back surface of a radar according to a fifth embodiment.

FIG. 12 is a block diagram showing an example of an internal configuration of the radar according to the fifth embodiment.

FIG. 13 is a functional block diagram showing an example of a function of the radar according to the fifth embodiment.

FIG. 14 is a flowchart showing an example of a procedure of LED light emission control processing by the radar according to the fifth embodiment.

FIG. 15A is a diagram showing a first modification of an arrangement of LEDs in the radar according to the fifth embodiment.

FIG. 15B is a diagram showing a second modification of an arrangement of LEDs in the radar according to the fifth embodiment.

FIG. 16 is a flowchart showing an example of a procedure of LED light emission control processing by a radar according to a sixth embodiment.

### DETAILED DESCRIPTION

### Problems to be Solved by Present Disclosure

Radar is also used for traffic monitoring at intersections, roads, etc. Sensors other than radar, such as Light Detection and Ranging (LiDAR), are also used for traffic monitoring. A sensor for traffic monitoring (hereinafter also referred to as “infrastructure sensor”) is installed at an intersection or a road, and an angle of the installed infrastructure sensor is adjusted. The infrastructure sensor needs to accurately detect vehicles for each of the lanes, but it is not easy to confirm whether or not the vehicles has been accurately detected.

### Advantageous Effects of Present Disclosure

According to the present disclosure, the detection accuracy of the infrastructure sensor can be confirmed.

### DESCRIPTION OF EMBODIMENTS OF PRESENT DISCLOSURE

The following lists and describes an overview of embodiments of the present disclosure.

(1) A display apparatus according to an embodiment of the present disclosure includes a first result display portion configured to display a first traffic volume detected by an infrastructure sensor configured to detect vehicles in a measurement area, and a second result display portion configured to display reference information indicating a second traffic volume obtained by a means different from the infrastructure sensor during a same period as a period during which the infrastructure sensor detects the first traffic volume. Accordingly, a user can confirm the detection accuracy of the infrastructure sensor by comparing the number of the vehicles detected by the infrastructure sensor with the reference information.

(2) In the display apparatus, an image obtained by a camera configured to photograph the measurement area during the period may be displayed. Accordingly, it is possible to count the number of the vehicles included in the image and to compare the count result with the number of the vehicles detected by the infrastructure sensor.

(3) The display apparatus may further include a collation unit configured to collate the first traffic volume with the second traffic volume recognized by subjecting the image to an image recognition process. Accordingly, the number of the vehicles detected by the infrastructure sensor can be collated with the number of the vehicles recognized from the image.

(4) The second traffic volume may be a number of the vehicles having passed a specific spot in the measurement area during the period, the number being input by a user. Accordingly, the user can count the number of the vehicles having passed the specific spot (for example, a specific point on a road) in the measurement area during the detection period, and compare the number of the vehicles detected by the infrastructure sensor with the count result.

(5) The second result display portion may include a count portion configured to receive an operation by the user for counting the number of the vehicles having passed the specific spot, and a counted value display portion configured to display the number of the vehicles having passed the specific spot, based on the operation by the user on the count portion. Accordingly, the number of vehicles can be counted by the user selecting the count portion, and the counting result is displayed on the counted value display portion. The user can confirm the detection accuracy of the infrastructure sensor by comparing the number of vehicles displayed on the first result display portion with the number of vehicles displayed on the counted value display portion.

(6) The first result display portion may be configured to, if the measurement area includes a plurality of lanes, display, for each of the lanes, the first traffic volume detected by the infrastructure sensor during the period, and the second result display portion may be configured to display, for each of the lanes, the count portion and the counted value display portion in correspondence with each other. Accordingly, the user can compare the number of vehicles detected by the infrastructure sensor with the counted value for each of the lanes.

(7) The display apparatus may further include a collation result display portion configured to display a collation result between the first traffic volume and the second traffic volume. Accordingly, the user can confirm the detection accuracy of the infrastructure sensor by the collation result displayed on the collation result display portion.

(8) The display apparatus may further include a record unit configured to record a screen on which a collation result between the first traffic volume and the second traffic volume and a moving image obtained by a camera configured to photograph the measurement area during the period are displayed. This can provide evidence that the infrastructure sensor is operating properly.

(9) Accuracy of detection by the infrastructure sensor, the accuracy being calculated based on a ratio between the first traffic volume and the second traffic volume, and time information indicating the period may be displayed. Accordingly, the user can confirm the detection accuracy of the infrastructure sensor together with the time information. For example, by recording a confirmation screen on which accuracy is displayed together with time information, the degree of detection accuracy in the detection period can be confirmed afterward.

(10) The time information may include a date and a time on and at which the period ends. Accordingly, the user can confirm the detection accuracy along with the date and the time. For example, by recording a confirmation screen on which the accuracy is displayed together with the time information, it is possible to confirm the degree of detection accuracy at which date and time afterward.

(11) A computer program according to an embodiment of the present disclosure is a computer program for causing a computer to execute: a process of displaying, on a display apparatus, a first traffic volume of vehicles detected by an infrastructure sensor configured to detect the vehicles in a measurement area, and a process of displaying, on the display apparatus, reference information indicating a second traffic volume obtained by a means different from the infrastructure sensor during a same period as a period during which the infrastructure sensor detects the first traffic volume. Accordingly, the user can confirm the detection accuracy of the infrastructure sensor by comparing the number of the vehicles detected by the infrastructure sensor with the reference information.

(12) The computer program may cause the computer to execute a process of displaying, on the display apparatus, an image obtained by a camera configured to photograph the measurement area during the period. Accordingly, it is possible to count the number of the vehicles included in the image and to compare the count result with the number of the vehicles detected by the infrastructure sensor.

(13) The computer program may cause the computer to execute a process of collating the first traffic volume with the second traffic volume recognized by subjecting the image to an image recognition process. Accordingly, the number of the vehicles detected by the infrastructure sensor can be collated with the number of the vehicles recognized from the image.

(14) The second traffic volume may be a number of the vehicles having passed a specific spot in the measurement area during the period, the number being input by a user. Accordingly, the user can count the number of the vehicles having passed a specific spot (for example, a specific point on a road) of the measurement area during the detection period, and compare the number of the vehicles detected by the infrastructure sensor with the count result.

(15) The computer program may cause the computer to execute: a process of displaying, on the display apparatus, a count portion configured to receive an operation by the user for counting the number of the vehicles having passed the specific spot, and a process of displaying, on the display apparatus, the number of the vehicles having passed the specific spot, based on the operation by the user on the count portion. The user can confirm the detection accuracy of the infrastructure sensor by comparing the number of vehicles displayed on the first result display portion with the number of vehicles displayed on the counted value display portion.

(16) The computer program may cause the computer to execute if the measurement area includes a plurality of lanes, a process of displaying, on the display apparatus, for each of the lanes, the first traffic volume detected by the infrastructure sensor during the period, and displaying, on the display apparatus, for each of the lanes, the count portion and the counted value display portion in correspondence with each other. Accordingly, the user can compare the number of vehicles detected by the infrastructure sensor with the counted value for each of the lanes.

(17) The computer program may cause the computer to execute a process of displaying, on the display apparatus, a collation result between the first traffic volume and the second traffic volume. Accordingly, the user can confirm the detection accuracy of the infrastructure sensor through the collation result displayed on the collation result display portion.

(18) The reference information may be a moving image obtained by a camera configured to photograph the measurement area, the computer program may cause the computer to further execute a process of recording a screen on which the collation result and the moving image are displayed. This can provide evidence that the infrastructure sensor is operating properly.

(19) The computer program may cause the computer to execute a process of displaying, on the display apparatus, detection accuracy by the infrastructure sensor, the accuracy being calculated based on a ratio between the first traffic volume and the second traffic volume, and time information indicating the period. Accordingly, the user can confirm the detection accuracy by the infrastructure sensor together with the time information. For example, by recording a confirmation screen on which accuracy is displayed together with time information, the degree of detection accuracy in the detection period can be confirmed afterward.

(20) The time information may include a date and a time on and at which the period ends. For example, by recording a confirmation screen on which accuracy is displayed together with time information, it is possible to confirm the degree of detection accuracy at which date and time afterward.

### DETAILS OF EMBODIMENTS OF PRESENT DISCLOSURE

The details of embodiments of the present disclosure will now be described with reference to the drawings. At least a part of the embodiments described below may be arbitrarily combined.

### 1. FIRST EMBODIMENT

### [1-1. Radar]

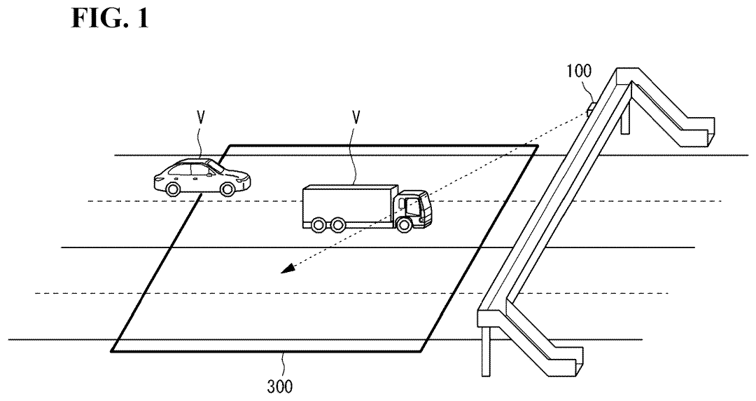

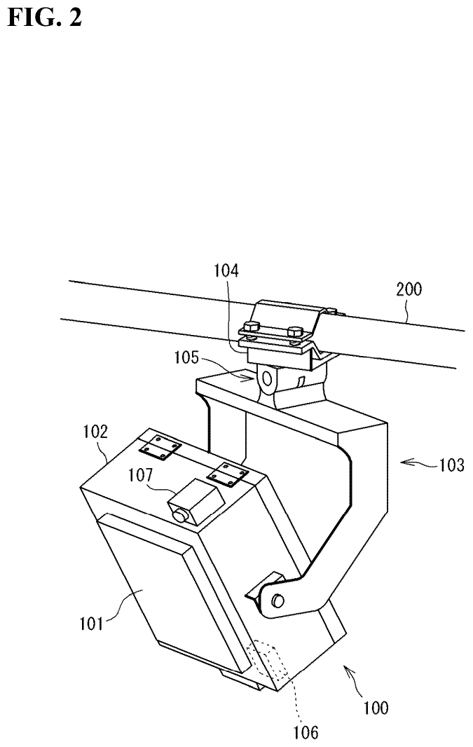

FIG. 1 shows an example of a use of a radar according to a first embodiment. A radar 100 according to the present embodiment is a radio radar (infrastructure sensor) for traffic monitoring. Radar 100 is attached to an arm 200 (see FIG. 2) or the like provided at an intersection or on a road. Radar 100 is a millimeter wave radar, and is a radio wave sensor. Radar 100 detects an object (for example, a vehicle V) in a measurement area 300 by irradiating measurement area 300 on a road with radio waves (millimeter waves) and receiving the reflected waves. More specifically, radar 100 can detect a distance from radar 100 to vehicle V running on the road, a speed of vehicle V, and a horizontal angle of a position where vehicle V exists with respect to a radio wave irradiation axis of the radar.

Radar 100 is installed so that the direction of the radio wave irradiation axis (the method indicated by the dashed line in FIG. 1, hereinafter referred to as “reference direction”) faces measurement area 300. If the reference direction does not correctly face measurement area 300, radar 100 cannot correctly detect an object in measurement area 300. Therefore, the angle of radar 100 is adjusted so that the reference direction is directed to measurement area 300.

FIG. 2 is a perspective view showing an example of an appearance configuration of radar 100 according to the first embodiment. As shown in FIG. 2, radar 100 includes a transceiving surface 101 for transceiving millimeter waves. The reference direction is a normal direction of transceiving surface 101. Radar 100 incorporates at least one transmitting antenna and a plurality of (e.g., two) receiving antennas (not shown). Radar 100 transmits a modulated wave which is a millimeter wave from a transmitting antenna through transceiving surface 101. The modulated wave hits an object and is reflected, and the receiving antenna receives the reflected wave. Radar 100 performs signal processing on the transmission wave signal and the reception wave signal by a signal processing circuit (not shown), and detects the distance to the object, the angle at which the object exists (hereinafter referred to as “object position”), and the speed of the object.

Radar 100 is configured to be capable of adjusting an installation angle. Radar 100 includes a radar body 102, a depression angle adjustment unit 103, a horizontal angle adjustment unit 104, and a roll angle adjustment unit 105. Radar body 102 is formed in a box shape, and depression angle adjustment unit 103 is attached to side surfaces of radar body 102. Radar body 102 is rotatable about the horizontal axis by depression angle adjustment unit 103, and thus the depression angle of radar body 102 is adjusted. Radar body 102 connected to roll angle adjustment unit 105 by depression angle adjustment unit 103 can be rotated in the left and right direction toward transceiving surface 101 by roll angle adjustment unit 105, thereby adjusting the roll angle of radar body 102. Horizontal angle adjustment unit 104 is fixed to a pole which is an installation target. Radar body 102 connected to horizontal angle adjustment unit 104 by depression angle adjustment unit 103 and roll angle adjustment unit 105 can be rotated around the vertical axis by horizontal angle adjustment unit 104, thereby adjusting the horizontal angle of radar body 102.

Radar 100 detects vehicle V for each of the lanes. Radar 100 specifies the coordinates of the detected vehicle V in the set coordinate space. A region of each of the lanes is set in the coordinate space, and the lane in which vehicle V runs is specified depending on in which region the coordinates of vehicle V are present. A storage unit 106 which is, for example, a non-volatile memory is built-in radar body 102, and setting information of the lane in the coordinate space is stored in storage unit 106.

As shown in FIG. 2, a camera 107 is attached to radar body 102. Camera 107 is fixed to radar body 102, and the optical axis of camera 107 is parallel to the radio wave irradiation axis. That is, camera 107 faces in the reference direction. Thus, camera 107 can photograph of the measurement area.

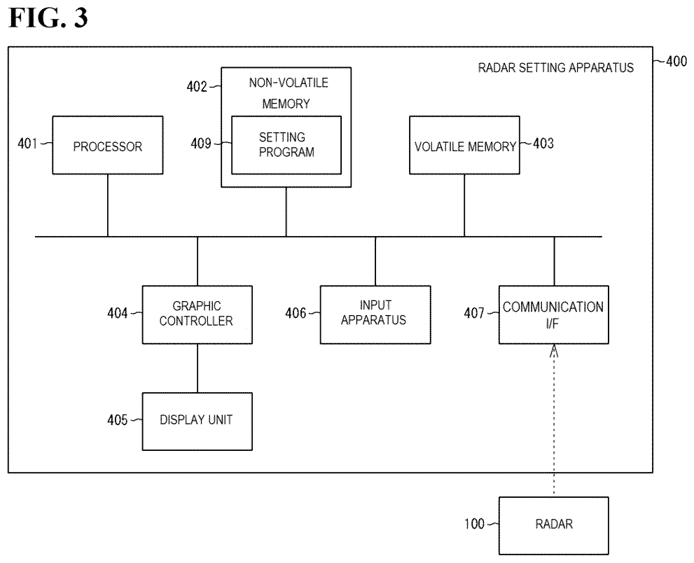

Radar body 102 includes a communication unit (not shown). As shown in FIG. 3, radar 100 is connected to a radar setting apparatus 400 via a communication unit in a wired or wireless manner. Radar setting apparatus 400 is used to set the region of the lanes in the coordinate space of radar 100. An image obtained by camera 107 (hereinafter referred to as “camera image”) is transmitted to radar setting apparatus 400. Information on vehicle V detected by radar 100 (the position of vehicle V, the lane in which vehicle V runs, the number of the vehicles V detected for each of the lanes, and the like) is transmitted to radar setting apparatus 400. Radar setting apparatus 400 can transmit setting information of the region of the lanes in the coordinate space of radar 100 to radar 100. The transmitted setting information is stored in storage unit 106, and the setting information is updated.

### [1-2. Configuration of Radar Setting Apparatus]

FIG. 3 is a block diagram showing an example of a configuration of radar setting apparatus 400 according to the first embodiment. Radar setting apparatus 400 is an example of a display apparatus. Radar setting apparatus 400 is composed of a portable information terminal such as a smartphone, a tablet, or a portable computer. Radar setting apparatus 400 includes a processor 401, a non-volatile memory 402, a volatile memory 403, a graphic controller 404, a display unit 405, an input apparatus 406, and a communication interface (communication I/F) 407.

Volatile memory 403 is a semiconductor memory, such as a static random access memory (SRAM), dynamic random access memory (DRAM), etc. Non-volatile memory 402 is, for example, a flash memory, a hard disk, a read only memory (ROM), or the like. Non-volatile memory 402 stores a setting program 409 which is a computer program and data used for execution of setting program 409. Radar setting apparatus 400 is configured to include a computer, and each function of radar setting apparatus 400 is implemented when setting program 409, which is a computer program stored in a storage apparatus of the computer, is executed by processor 401. Setting program 409 can be stored in a recording medium such as a flash memory, a ROM, or a CD-ROM. Processor 401 executes setting program 409 and causes display unit 405 to display a setting screen as will be described later.

Processor 401 is, for example, a central processing unit (CPU). However, processor 401 is not limited to the CPU. Processor 401 may be a graphics processing unit (GPU). Processor 401 may be, for example, an application specific integrated circuit (ASIC) or a programmable logic device such as a gate array or a field programmable gate array (FPGA). In this case, the ASIC or the programmable logic device is configured to be able to execute the same processing as setting program 409.

Graphic controller 404 is connected to display unit 405, and controls display in display unit 405. Graphic controller 404 includes, for example, a GPU and a video RAM (VRAM), holds data to be displayed on display unit 405 in the VRAM, periodically reads video data for one frame from the VRAM, and generates a video signal. The generated video signal is output to display unit 405, and the video is displayed on display unit 405. The functions of graphic controller 404 may be included in processor 401. A portion of area of volatile memory 403 may be used as a VRAM.

Display unit 405 includes, for example, a liquid crystal panel or an organic electroluminescence (OEL) panel. Display unit 405 can display text and figure information. Input apparatus 406 includes, for example, a capacitive or pressure-sensitive touch pad overlaid on display unit 405. Input apparatus 406 may be a pointing device such as a keyboard and a mouse. Input apparatus 406 is used for inputting information to radar setting apparatus 400.

Communication I/F 407 can communicate with an external apparatus in a wired or wireless manner. Communication I/F 407 can receive the camera image output from camera 107. Communication I/F 407 can receive information of vehicle V detected by radar 100. Communication I/F 407 can transmit the setting information of the region of the lane in the coordinate space of radar 100 to radar 100.

### [1-3. Function of Radar Setting Apparatus]

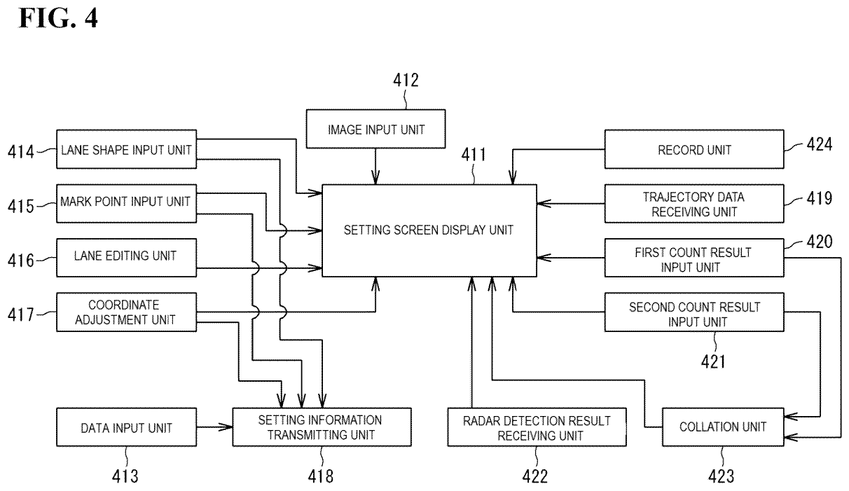

FIG. 4 is a functional block diagram showing an example of a function of radar setting apparatus 400 according to the first embodiment. When processor 401 executes setting program 409, radar setting apparatus 400 functions as a setting screen display unit 411, an image input unit 412, a data input unit 413, a lane shape input unit 414, a mark point input unit 415, a lane editing unit 416, a coordinate adjustment unit 417, a setting information transmitting unit 418, a trajectory data receiving unit 419, a first count result input unit 420, a second count result input unit 421, a radar detection result receiving unit 422, a collation unit 423, and a record unit 424.

Setting screen display unit 411 is implemented by display unit 405. Setting screen display unit 411 can display a setting screen. The setting screen is a screen for setting the region of lanes in the coordinate space of radar 100 (hereinafter referred to as “lane region setting”).

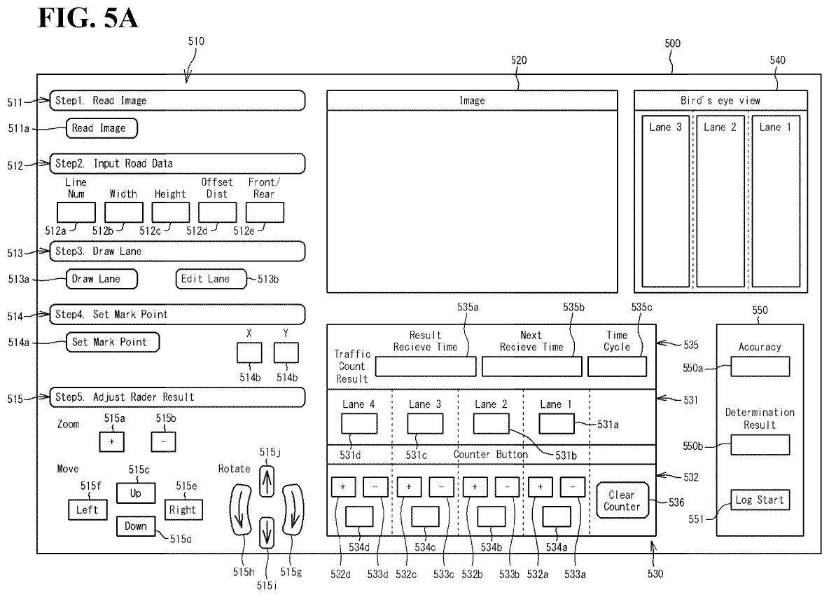

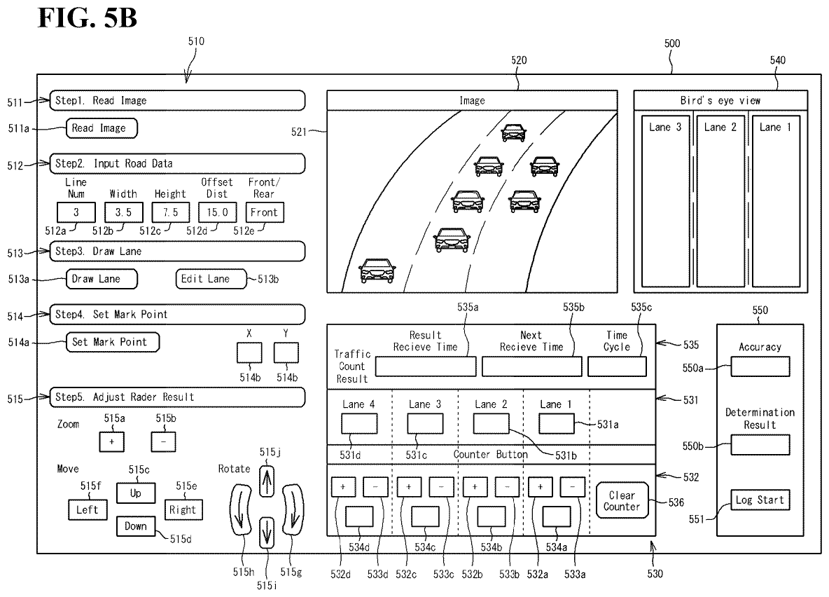

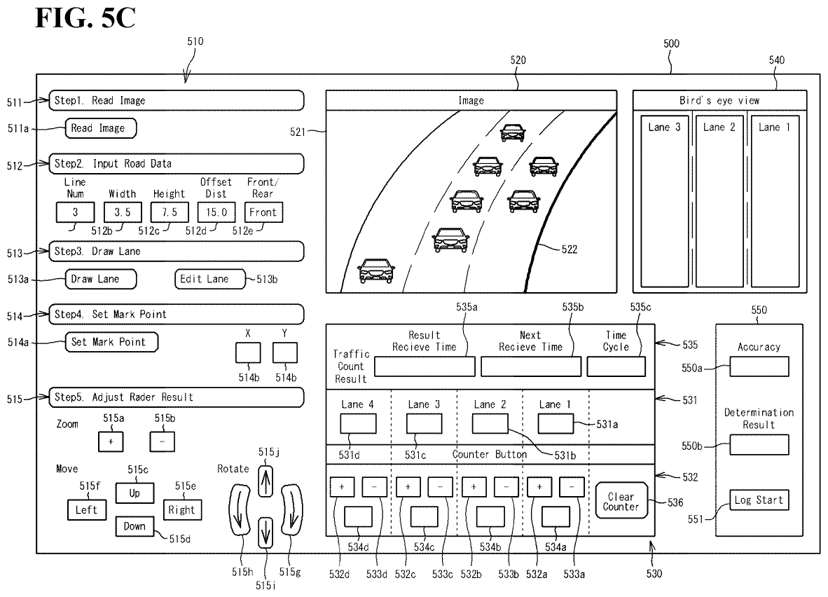

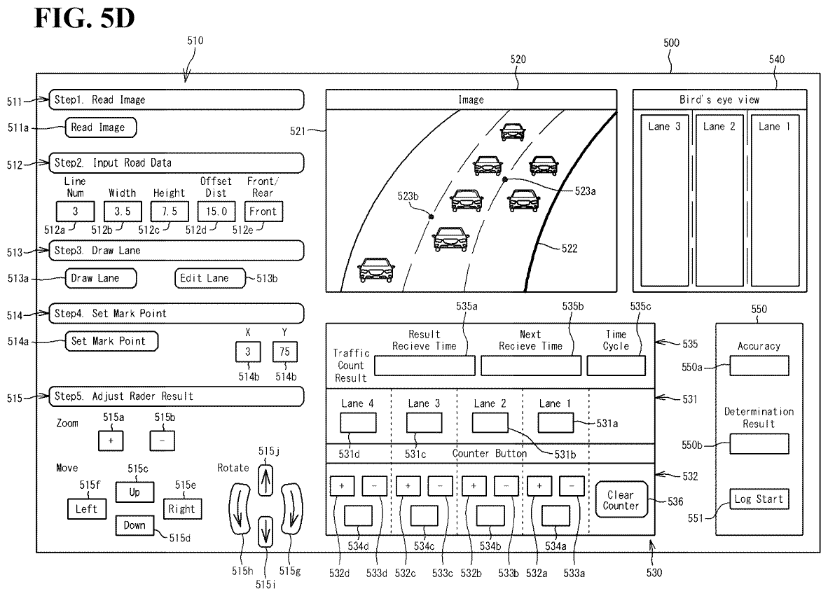

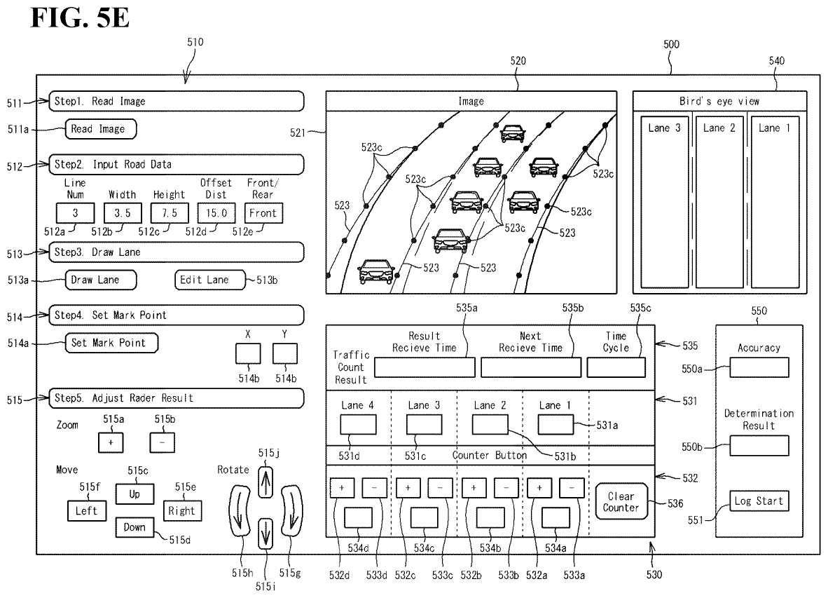

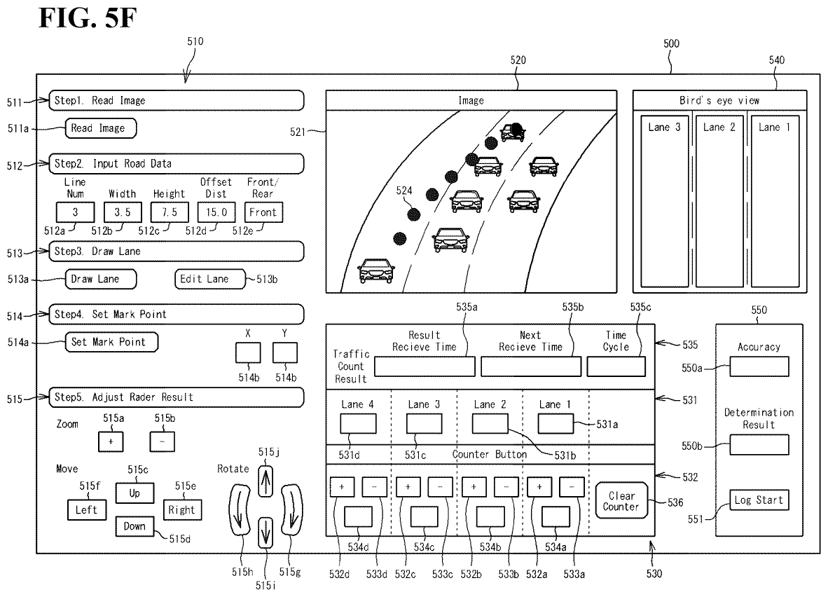

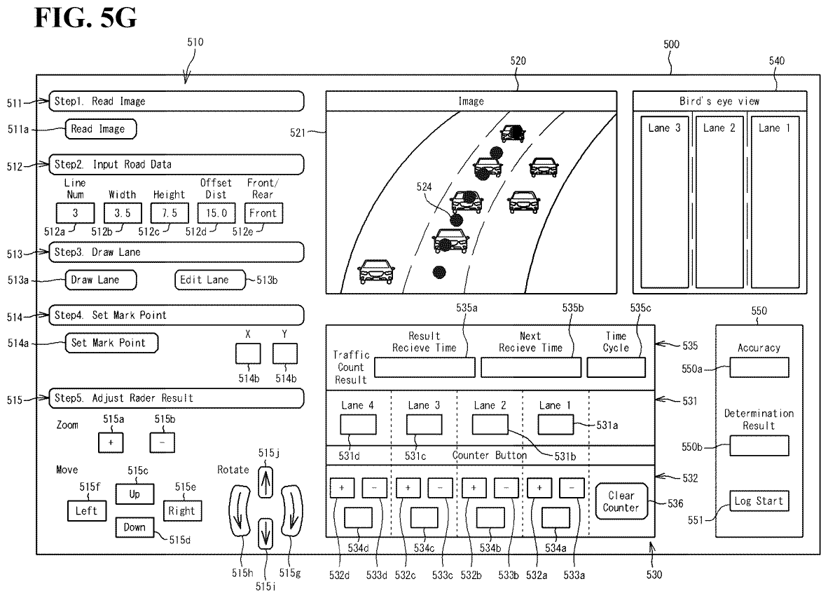

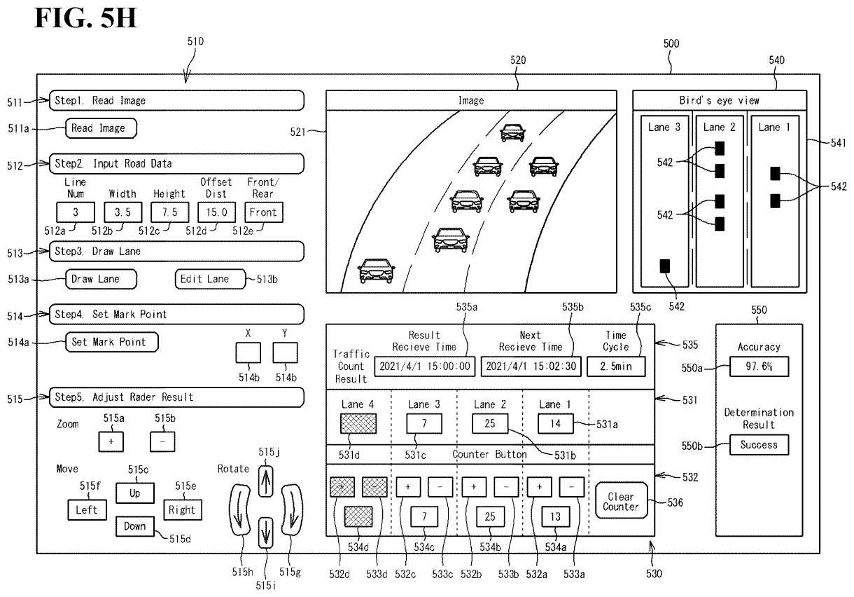

FIG. 5A is a diagram showing an example of a setting screen according to the first embodiment. As shown in FIG. 5A, a setting screen 500 includes an user operation portion 510, an image display portion 520, a traffic count result display portion 530, and a bird's eye view display portion 540.

User operation portion 510 is a region for receiving an operation from a user. The user can input various information to radar setting apparatus 400 by operating user operation portion 510. User operation portion 510 includes an image reading instruction portion 511, a basic data input portion 512, a lane drawing instruction portion 513, a mark point input instruction portion 514, and a lane adjustment portion 515.

Image reading instruction portion 511 includes an image reading button 511a. Image reading button 511a is a button for instructing radar setting apparatus 400 to read the camera image output from camera 107. Image display portion 520 is a region for displaying the read camera image.

Reference is again made to FIG. 4. When the user selects image reading button 511a, image input unit 412 receives an input of the camera image output from radar 100. Setting screen display unit 411 displays the input camera image on image display portion 520. The camera image may be a still image or a moving image. When counting of the number of vehicles to be described later is performed using a camera image, the camera image is preferably a moving image. In order to count the number of vehicles, a plurality of still images may be displayed in order of photographing time. When the camera image is a moving image or a plurality of still images, reading of the image is continuously performed. Accordingly, a real-time camera image is displayed on image display portion 520.

Reference is again made to FIG. 5A. Basic data input portion 512 is used to input the number of lanes and the lane width in measurement area 300, the installation height and the offset amount of radar 100, and the vehicle detection method, which are basic data used for lane region setting (hereinafter collectively referred to as “basic data”). The basic data is used for setting a coordinate system of radar 100, initial setting of a lane region in a coordinate space, and the like. Basic data input portion 512 includes a number-of-lanes input portion 512a, a lane width input portion 512b, an installment height input portion 512c, an offset amount input portion 512d, and a detection method input portion 512e. Number-of-lanes input portion 512a is an input box and is used to input the number of lanes in measurement area 300. Lane width input portion 512b is an input box and is used to input the width of the lane. Installment height input portion 512c is an input box and is used to input the installation height of radar 100 from the ground surface. Offset amount input portion 512d is an input box and is used to input the offset amount of the attachment location of radar 100 with respect to the origin in the road width direction. The origin is set, for example, at the left end position of the road as viewed from the attachment location of radar 100. Detection method input portion 512e is a selection box. For example, if detection method input portion 512e is selected, a drop-down menu is displayed. The drop-down menu includes two items of front measurement (a method of detecting vehicles from a front direction) and rear measurement (a method of detecting vehicles from a rear direction). Detection method input portion 512e is used to select one of the front measurement and the rear measurement.

FIG. 5B is a diagram showing an example of a setting screen on which basic data is input. In FIG. 5B, the number of lanes “3” is input in number-of-lanes input portion 512a, the lane width “3.5” is input in lane width input portion 512b, the installation height “7.5” is input in installment height input portion 512c, the offset amount “15.0” is input in offset amount input portion 512d, and “Front” indicating front measurement is designated in detection method input portion 512e.

Reference is again made to FIG. 4. Data input unit 413 receives basic data input to basic data input portion 512 by the user. Setting information transmitting unit 418 transmits the basic data received by data input unit 413 to radar 100.

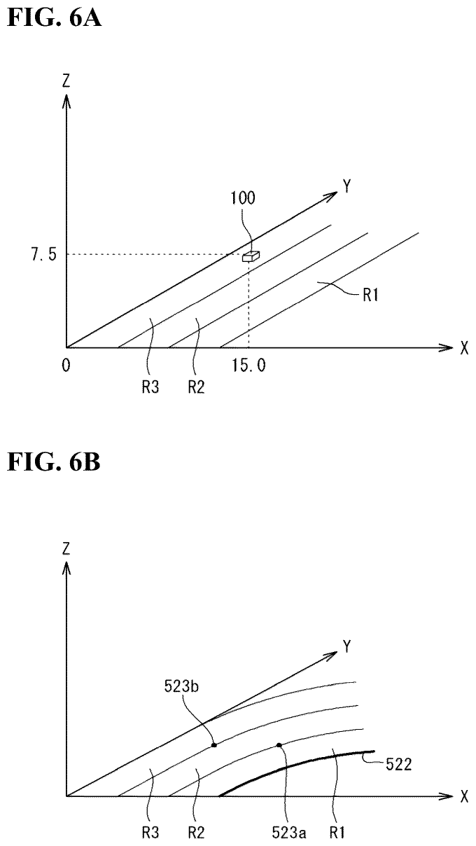

Radar 100 sets a coordinate system based on the received basic data and initially sets a lane region in a coordinate space. FIG. 6A is a diagram for explaining an example of initial setting of a lane region in a coordinate space of a radar. Radar 100 sets the origin of the coordinates and the coordinate position of radar 100 based on, for example, the offset amount and the installation height. For example, the coordinate system having an X axis extending in the road width direction, a Y axis extending in the road length direction, and a Z axis extending in the vertical direction is set. In FIG. 6A, the coordinate positions of the origin 0 and radar 100 are set based on the offset amount “15.0” and the installation height “7.5”. Further, radar 100 sets a lane region based on the number of lanes and the lane width. In FIG. 6A, lane regions R1, R2, and R3 in the coordinate space are set based on the number of lanes “3” and the lane width “3.5”. For example, the lane is set to be linear in the initial setting.

Reference is again made to FIG. 5A. Lane drawing instruction portion 513 includes a lane drawing instruction button 513a and a lane editing button 513b. Lane drawing instruction button 513a is a button for instructing start of input of a line indicating a shape of a lane in measurement area 300 (hereinafter, referred to as “lane shape line”). When lane drawing instruction button 513a is selected, it is possible to draw a line (straight line or curved line) in image display portion 520. FIG. 5C is a diagram showing an example of a setting screen on which a lane shape line 522 is drawn. As shown in FIG. 5C, the user can draw lane shape line 522 superimposed on the image of the road displayed on image display portion 520. For example, when input apparatus 406 is a touch pad, the user can draw lane shape line 522 by tracing a lane line such as a center line or a lane boundary line on a road in a camera image 521 displayed on image display portion 520 with a finger or a stylus.

Lane editing button 513b is a button for instructing start of editing of the set lane region. When lane editing button 513b is selected, the setting screen shifts to the editing mode, and the lane region set in radar 100 can be edited. The editing of the lane region will be described later.

Reference is again made to FIG. 4. Lane shape input unit 414 receives lane shape line 522 drawn on camera image 521 by the user selecting lane drawing instruction button 513a, and receives lane shape line 522 edited by the user selecting lane editing button 513b.

Reference is again made to FIG. 5A. Mark point input instruction portion 514 includes a mark point input button 514a and a coordinate input portion 514b. Mark point input button 514a is a button for the user to input a mark point to camera image 521 displayed on image display portion 520. Coordinate input portion 514b is an input box and is used to input the coordinate value of the mark point. FIG. 5D is a diagram showing an example of a setting screen on which a mark point is input. Since the mark point is a position on the road, the Z value is “0”. The user can input an X value and a Y value of the mark point to coordinate input portion 514b. In the example of FIG. 5D, the X value of “3” and the Y value of “75” are input. The user can select mark point input button 514a in a state in which coordinate values are input to coordinate input portion 514b. When mark point input button 514a is selected, it is possible to input mark points 523a and 523b in image display portion 520.

The mark points and the coordinate values are used to associate the lane shape indicated by the drawn lane shape line 522 with the coordinates. That is, when the lane is curved, the mark point and the coordinate value are used to specify at which position the lane is curved. Therefore, it is preferable that two or more mark points are given. To input two mark points 523a and 523b, the user selects mark point input button 514a in a state where the first coordinate value (3, 75) is input to coordinate input portion 514b, inputs mark point 523a on camera image 521, and further selects mark point input button 514a in a state where the second coordinate value (−0.5, 45) is input to coordinate input portion 514b, and inputs mark point 523b on camera image 521.

Reference is again made to FIG. 4. The user inputs coordinate values to coordinate input portion 514b, selects mark point input button 514a, and inputs mark points 523a and 523b on camera image 521. Mark point input unit 415 receives mark points 523a and 523b and coordinate values input by the user. Setting screen display unit 411 displays lane shape line 522 received by lane shape input unit 414 and mark points 523a and 523b received by mark point input unit 415. Setting information transmitting unit 418 transmits lane setting data indicating lane shape line 522 and mark points 523a and 523b to radar 100.

Radar 100 sets lane regions R1, R2, and R3 in the coordinate space based on the received lane setting data. FIG. 6B is a diagram for explaining an example of setting of a lane region in a coordinate space of a radar. Radar 100 specifies the shape of the lane based on lane shape line 522 and mark points 523a and 523b, and changes lane regions R1, R2, and R3 according to the specified shape. In the example of FIG. 6B, the curvature and the turning position of the lane are specified by lane shape line 522 and mark points 523a and 523b, and lane regions R1, R2, and R3 are set to be curved according to the curvature and the turning position.

Reference is again made to FIG. 4. Lane editing unit 416 edits lane regions R1, R2, and R3 set in radar 100. Lane editing unit 416 receives lane region data including coordinate values of lane regions R1, R2, and R3 from radar 100. Lane editing unit 416 edits lane regions R1, R2, and R3 in accordance with an editing instruction of lane regions R1, R2, and R3 given by the user.

Reference is again made to FIG. 5A. When lane editing button 513b is selected, radar setting apparatus 400 transmits a request for lane region data to radar 100. Upon receiving the request, radar 100 transmits the lane region data to radar setting apparatus 400. When radar setting apparatus 400 receives the lane region data, setting screen 500 shifts to the editing mode, and the lane region set in radar 100 can be edited. FIG. 5E is a diagram showing an example of a setting screen in the editing mode of a lane region. As shown in FIG. 5E, in the editing mode, a lane shape line 523 indicating the lane line of each of the lanes is displayed so as to be superimposed on camera image 521, and nodes 523c are displayed at a plurality of positions of lane shape line 523. Node 523c is a point that can be selected and moved. For example, the user can select node 523c to be moved by drag-and-drop and move it to the desired position. When the user lifts the finger or the stylus off node 523c, the selection and the movement of node 523c are finished, and lane shape line 523 is changed according to the changed position of node 523c. Accordingly, the user can edit lane shape line 523 deviated from the lane line so as to overlap with the lane line.

Reference is again made to FIG. 4. Lane editing unit 416 generates edit data including coordinate values defining the edited lane regions R1, R2, and R3 based on the edited lane shape line 523, and transmits the edit data to radar 100. Radar 100 changes the settings of lane regions R1, R2, and R3 according to the received edit data.

When lane regions R1, R2, and R3 in the coordinate space of radar 100 are set as described above, radar 100 generates trajectory data including time-series position data of one or a plurality of vehicles V and transmits the trajectory data to radar setting apparatus 400. Trajectory data receiving unit 419 receives the trajectory data transmitted from radar 100.

Setting screen display unit 411 displays the running trajectory of vehicle V detected by radar 100 in a superimposed manner on camera image 521 based on the received trajectory data. FIG. 5F is a diagram showing an example of a setting screen on which a running trajectory of a vehicle is displayed. As shown in FIG. 5F, for example, a vehicle V's running trajectory 524 may be represented by a plurality of figures showing the vehicle's position in a time-series. The user can determine whether or not the lane region in the coordinate space of radar 100 is correctly set by confirming whether or not running trajectory 524 deviates from the lane. In the example of FIG. 5F, running trajectory 524 deviates from the lane. Therefore, the user determines that the lane region in the coordinate space of radar 100 is not correctly set.

Lane adjustment portion 515 is used to adjust the lane region set in radar 100. Lane adjustment portion 515 includes an enlarge button 515a, a reduce button 515b, a move up button 515c, a move down button 515d, a move right button 515e, a move left button 515f, a clockwise button 515 g, a counterclockwise button 515h, a front rotation button 515i, and a back rotation button 515j.

Enlarge button 515a is a button for enlarging and displaying camera image 521 and running trajectory 524. Reduce button 515b is a button for reducing and displaying camera image 521 and running trajectory 524. The user selects enlarge button 515a to enlarge and display camera image 521 and running trajectory 524, and selects reduce button 515b to reduce and display camera image 521 and running trajectory 524.

Move up button 515c is a button for moving running trajectory 524 upward with respect to camera image 521, and move down button 515d is a button for moving running trajectory 524 downward with respect to camera image 521. Move right button 515e is a button for moving running trajectory 524 in the right direction with respect to camera image 521, and move left button 515f is a button for moving running trajectory 524 in the left direction with respect to camera image 521. When adjusting the position of the running trajectory, the user selects move up button 515c, move down button 515d, move right button 515e, or move left button 515f.

Clockwise button 515g is a button for rotating running trajectory 524 clockwise with respect to camera image 521, and counterclockwise button 515h is a button for rotating running trajectory 524 counterclockwise with respect to camera image 521. Front rotation button 515i is a button for rotating running trajectory 524 to the front side in the depth direction of the screen, and back rotation button 515j is a button for rotating running trajectory 524 to the rear side in the depth direction of the screen. When adjusting the angle of the running trajectory, the user selects clockwise button 515g, counterclockwise button 515h, front rotation button 515i, or back rotation button 515j. The user adjusts the position and the angle of running trajectory 524 so that running trajectory 524 is correctly within the lane.

FIG. 5G is a diagram showing an example of the setting screen after the position and the angle of running trajectory 524 has been adjusted. When enlarge button 515a, reduce button 515b, move up button 515c, move down button 515d, move right button 515e, move left button 515f, clockwise button 515g, counterclockwise button 515h, front rotation button 515i, or back rotation button 515j is operated to instruct adjustment of the position and the angle of running trajectory 524, as shown in FIG. 5G, the position and the angle of running trajectory 524 displayed on setting screen 500 change in accordance with the instruction. Accordingly, the user can easily determine whether or not running trajectory 524 is correctly within the lane by confirming running trajectory 524 superimposed and displayed on camera image 521.

Reference is again made to FIG. 4. Coordinate adjustment unit 417 receives an adjustment direction and an adjustment amount of coordinates of running trajectory 524 input from enlarge button 515a, reduce button 515b, move up button 515c, move down button 515d, move right button 515e, move left button 515f, clockwise button 515g, counterclockwise button 515h, front rotation button 515i, or back rotation button 515j. Setting screen display unit 411 changes the position and the angle of running trajectory 524 on setting screen 500 according to the adjustment direction and the adjustment amount of the coordinates of running trajectory 524 received by coordinate adjustment unit 417. Correction data is generated based on the adjustment direction and the adjustment amount of the coordinates of running trajectory 524 received by coordinate adjustment unit 417. Setting information transmitting unit 418 transmits the generated correction data to radar 100. Radar 100 adjusts lane regions R1, R2, and R3 in the coordinate space based on the received correction data.

Radar setting apparatus 400 has a function of confirming detection accuracy of radar 100 after the lane region setting of radar 100 is performed as described above. This function is provided by first count result input unit 420, second count result input unit 421, radar detection result receiving unit 422, collation unit 423, and setting screen display unit 411.

When the lane region setting is completed, radar 100 transmits traffic count data indicating the number of the vehicles detected for each of the lanes (first traffic volume). The first traffic volume is a number of the vehicles having passed a specific spot (for example, a vehicle sensing line set in a specific spot of a road) in measurement area 300 during a detection period, which is detected by radar 100. Radar 100 counts the number of the vehicles for each of the lanes for each fixed detection period and transmits traffic count data. First count result input unit 420 receives the traffic count data transmitted from radar 100. Setting screen display unit 411 displays the number of vehicles detected for each of the lanes based on the received traffic count data.

Second count result input unit 421 receives the number of the vehicles (second traffic volume) for each of the lanes input by the user during the detection period. The user counts the second traffic volume by visually observing measurement area 300 or visually observing a moving image or a plurality of still images obtained by the camera that has captured measurement area 300, and inputs the counted second traffic volume to second count result input unit 421. The second traffic volume is the number of the vehicles having passed a specific spot (for example, a vehicle sensing line set at a specific spot of a road) in measurement area 300 during the detection period. Setting screen display unit 411 displays the number of vehicles for each of the lanes input by the user.

Reference is again made to FIG. 5A. Setting screen 500 is also a confirmation screen for confirming detection accuracy of radar 100. Traffic count result display portion 530 includes a first count result display portion 531 and a second count result display portion 532. First count result display portion 531 is a region for displaying the number of vehicles for each of the lanes counted by radar 100. First count result display portion 531 is an example of a first result display portion. First count result display portion 531 includes a counted value display portion 531a for displaying the number of vehicles in the first lane, a counted value display portion 531b for displaying the number of vehicles in the second lane, a counted value display portion 531c for displaying the number of vehicles in the third lane, and a counted value display portion 531d for displaying the number of vehicles in the fourth lane.

Second count result display portion 532 includes count portions 532a and 533a for the user to count the number of the vehicles running in the first lane and a counted value display portion 534a for displaying the counted value of the first lane, count portions 532b and 533b for the use to count the number of vehicles in the second lane and a counted value display portion 534b for displaying the counted value of the second lane, count portions 532c and 533c for the use to count the number of vehicles in the third lane and a counted value display portion 534c for displaying the counted value of the third lane, and count portions 532d and 533d for the user to count the number of vehicles in the fourth lane and a counted value display portion 534d for displaying the counted value of the fourth lane. A plurality of users may count the number of vehicles in a plurality of lanes, or the same user may count the number of vehicles in a plurality of lanes. Second count result display portion 532 is an example of a second result display portion. Counted value display portion 534a displays a numerical value corresponding to the number of times count portions 532a and 533a are selected. Counted value display portion 534b displays a numerical value corresponding to the number of times count portions 532b and 533b are selected. Counted value display portion 534c displays a numerical value corresponding to the number of times count portions 532c and 533c are selected. Counted value display portion 534d displays a numerical value corresponding to the number of times count portions 532d and 533d are selected. Each of count portions 532a, 532b, 532c, and 532d is a button for incrementing the counted value, and each of count portions 533a, 533b, 533c, and 533d is a button for decrementing the counted value. Second count result display portion 532 is an example of the second result display portion, and the counted value of the number of vehicles for each of the lanes is an example of the reference information. Although the first result display portion and the second result display portion are displayed on setting screen 500 in the present embodiment, the first result display portion and the second result display portion may be displayed on screens different from each other. For example, the first result display portion may be displayed on setting screen 500, and the second result display portion may be displayed on a pop-up screen that is displayed when a button (not shown) on setting screen 500 is clicked.

Further, traffic count result display portion 530 includes a detection period display portion 535. Detection period display portion 535 includes a receiving time display portion 535a for displaying the time at which traffic count data was previously received from radar 100, a scheduled receiving time display portion 535b for displaying the time at which traffic count data is scheduled to be received next from radar 100, and a receiving interval display portion 535c for displaying the receiving interval of traffic count data.

FIG. 5H is a diagram showing an example of a setting screen displaying the number of vehicles for each of the lanes based on traffic count data and the number of vehicles for each of the lanes input by a user. In the example shown in FIG. 5H, the number of vehicles of the first lane, the second lane, and the third lane detected by radar 100 is “14”, “25”, and “7”, respectively, and the number of vehicles of the first lane, the second lane, and the third lane counted by the user is “13”, “25”, and “7”, respectively. “14” is displayed on counted value display portion 531a, “25” is displayed on counted value display portion 531b, and “7” is displayed on counted value display portion 531c. “13” is displayed on counted value display portion 534a, “25” is displayed on counted value display portion 534b, and “7” is displayed on counted value display portion 534c. The counted value display portion of radar 100 and the counted value display portion of the user of the same lane are vertically arranged. That is, counted value display portions 531a and 534a of the first lane are vertically arranged, counted value display portions 531b and 534b of the second lane are vertically arranged, counted value display portions 531c and 534c of the third lane are vertically arranged, and counted value display portions 531d and 534d of the fourth lane are vertically arranged. Thus, the user can easily compare the counted value by the radar with the counted value by the user.

Receiving time display portion 535a displays the receiving time of the previous traffic count data “2021/4/1 15:00:00”. Scheduled receiving time display portion 535b displays the scheduled receiving time of the next traffic count data “2021/4/1 15:02:30”. Receiving interval display portion 535c displays the traffic count data receiving interval “2.5 min”. In the present embodiment, a receiving time and a receiving interval of the traffic count data constitute a detection period. For example, when the counted value of the number of vehicles for each of the lanes by radar 100 and the counted value of the number of vehicles for each of the lanes by the user's visual observation are sufficiently close to each other, by displaying the detection period (receiving time and receiving interval of previous traffic count data) together with the counted value of the number of vehicles for each of the lanes by the radar 100 and the counted value of the number of vehicles for each of the lanes by the user's visual observation, the user can confirm that the detection accuracy of radar 100 is maintained during the detection period. For example, if the screen of FIG. 5H is recorded, the user can confirm afterward that the detection accuracy of radar 100 is maintained during the detection period.

For example, the unused counted value display portion may be shown to be disabled. In the example of FIG. 5H, since the number of lanes of measurement area 300 is 3, counted value display portions 531d and 534d of the fourth lane are not used. Therefore, counted value display portions 531d and 534d are displayed in gray, which is a color indicating that they are disabled. Additionally, the unused count portion may also be shown to be disabled. In the example of FIG. 5H, the unused count portions 532d and 533d are grayed out.

Traffic count result display portion 530 further includes a clear button 536 for clearing the display of the counted values on counted value display portions 531a, 531b, 531c, 531d, 534a, 534b, 534c and 534d. When clearing the counted value, the user can clear the counted value by selecting refresh button 536.

Reference is again made to FIG. 4. Radar 100 transmits detection result data indicating the detection result to radar setting apparatus 400. The detection result includes the position information of the detected vehicle V. Radar detection result receiving unit 422 receives the detection result data transmitted from radar 100. Setting screen display unit 411 displays the position of vehicle V included in the detection result data.

Reference is again made to FIG. 5H. Bird's eye view display portion 540 displays the position of vehicle V detected by radar 100 in a superimposed manner on the bird's eye view of measurement area 300. As shown in FIG. 5H, in bird's eye view display portion 540, a bird's eye view 541 of the lane included in measurement area 300 and a FIG. 542 indicating the position of vehicle V detected in each of the lanes are displayed. Radar 100 transmits detection result data at a predetermined cycle, and the position of FIG. 542 in bird's eye view display portion 540 is updated according to the detection result data received in radar setting apparatus 400. Accordingly, the real-time position of vehicle V is displayed on bird's eye view display portion 540. The user can confirm the detection accuracy of radar 100 by comparing the position of vehicle V in bird's eye view display portion 540 with, for example, camera image 521 in image display portion 520.

Reference is again made to FIG. 4. Collation unit 423 collates the number of vehicles detected by radar 100 during the detection period with the number of vehicles running in measurement area 300 counted by the user during the detection period. To be more specific, collation unit 423 collates the counted value of the number of vehicles for each of the lanes indicated by the traffic count data with the counted value of the number of vehicles for each of the lanes input by the user. Collation unit 423 calculates the accuracy of the counted value of the number of vehicles by radar 100 using the counted value of the number of vehicles by the user as a true value. In the example of FIG. 5H, since the counted value of the number of vehicles in the first lane by radar 100 is “14” and the counted value of the number of vehicles in the first lane by the user is “13”, the accuracy of the counted value of the number of vehicles in the first lane by radar 100 is 92.9%. Since the counted value of the number of vehicles in the second lane by radar 100 is “25” and the counted value of the number of vehicles in the second lane by the user is “25”, the accuracy of the counted value of the number of vehicles in the second lane by radar 100 is 100%. Since the counted value of the number of vehicles in the third lane by radar 100 is “7” and the counted value of the number of vehicles in the third lane by the user is “7”, the accuracy of the counted value of the number of vehicles in the third lane by radar 100 is 100%. If a plurality of lanes are included in measurement area 300, collation unit 423 calculates, for example, an average value of accuracies in the respective lanes as the accuracy of the detection result of radar 100. In the example of FIG. 5H, the accuracy is 97.6%.

Collation unit 423 can determine whether or not the detection accuracy is success or failure by comparing the calculated accuracy with the predetermined reference value. In the present embodiment, the reference value is 95%. In the example of FIG. 5H, collation unit 423 determines that detection accuracy is success. Setting screen display unit 411 displays at least one of the accuracy calculated by collation unit 423 and the determination result of success or failure of the detection accuracy determined by collation unit 423.

Reference is again made to FIG. 5H. When collation unit 423 collates the number of vehicles detected by radar 100 during the detection period with the number of vehicles running in measurement area 300 counted by the user during the detection period, a collation result is displayed on setting screen 500. A collation result display portion 550 is a region for displaying a collation result by collation unit 423. Collation result display portion 550 includes, for example, an accuracy display portion 550a for displaying the accuracy of the detection result of radar 100 and a determination result display portion 550b for displaying the determination result of the success or failure of the detection accuracy of radar 100. When the determination result is success, for example, the characters “Success” are displayed on determination result display portion 550b, and when the determination result is failure, for example, the characters “Failure” are displayed on determination result display portion 550b. By confirming collation result display portion 550, the user can recognize the detection accuracy of radar 100 and whether or not the detection accuracy is equal to or more than the predetermined reference.

Reference is again made to FIG. 4. Record unit 424 records a process of confirming the detection accuracy of radar 100 (hereinafter, referred to as “detection accuracy confirmation process”). The detection accuracy confirmation process includes receiving the traffic count data from radar 100 by first count result input unit 420, receiving the input from the user of the number of vehicles for each of the lanes by second count result input unit 421, receiving the detection result data from radar 100 by radar detection result receiving unit 422, and collating the number of vehicles for each of the lanes by collation unit 423. For example, the detection accuracy confirmation process is recorded as a moving image of setting screen 500 during a period from the start of the detection period to the display of the collation result of the number of vehicles (hereinafter referred to as “recording period”). The moving image of setting screen 500 includes the moving image of measurement area 300 in image display portion 520. Note that record unit 424 may record a plurality of still images of setting screen 500 at a plurality of points in time during the recording period instead of the moving image. Hereinafter, an example of recording a moving image of setting screen 500 will be described.

Reference is again made to FIG. 5A. Collation result display portion 550 includes a log start button 551. Log start button 551 is a button for instructing the start of recording of the detection accuracy confirmation process. When log start button 551 is selected by the user, recording of the moving image of setting screen 500 is started, and the instruction to start the detection period is transmitted to radar 100. When radar 100 receives the instruction to start the detection period, radar 100 starts the detection period. Further, as described above, radar 100 detects the number of vehicles for each of the lanes and transmits the traffic count data. When the user selects log start button 551, the number of vehicles for each of the lanes is input to radar setting apparatus 400 as described above. The input counted values are displayed on counted value display portions 531a, 531b, 531c, 531d, 534a, 534b, 534c, and 534d. Radar 100 detects the position of vehicle V in measurement area 300, and transmits detection result data. The position of vehicle V detected by radar 100 is displayed to be superimposed on the bird's eye view of measurement area 300 in bird's eye view display portion 540. When the detection period ends, collation unit 423 collates the number of vehicles detected by radar 100 during the detection period with the number of vehicles running in measurement area 300 counted by the user during the detection period. Collation unit 423 calculates the accuracy of the counted value of the number of vehicles by radar 100, and the calculated accuracy and the determination result of the success or failure of the detection accuracy of radar 100 are displayed on collation result display portion 550. The recording of the moving image on setting screen 500 is now stopped, and the recording period ends.

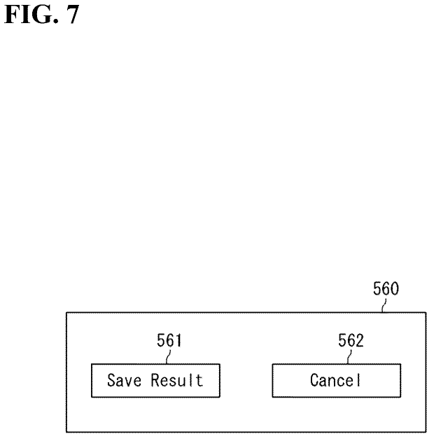

Reference is again made to FIG. 4. When the recording of the detection accuracy confirmation process is stopped, record unit 424 saves the recorded detection accuracy confirmation process (moving image of setting screen 500). For example, record unit 424 saves the moving image of setting screen 500 in accordance with an instruction from the user. When the recording of the detection accuracy confirmation process is stopped (i.e., when the recording period ends), a save instruction portion, which is a window for the user to instruct to save the moving image of the detection accuracy confirmation process, may be displayed. FIG. 7 is a diagram showing an example of a save instruction portion. A save instruction portion 560 includes a save instruction button 561 and a cancel button 562. Save instruction button 561 is a button for instructing saving of the moving image of the detection accuracy confirmation process, and cancel button 562 is a button for discarding the moving image of the detection accuracy confirmation process. When save instruction button 561 is selected by the user, moving image data of the detection accuracy confirmation process is saved in, for example, non-volatile memory 402. Note that the storage destination may be an internal memory of radar 100 or an external server connected to radar setting apparatus 400 via a network. When cancel button 562 is selected by the user, the moving image of the detection accuracy confirmation process is discarded. When one of save instruction button 561 and cancel button 562 is selected, save instruction portion 560 is closed.

Note that the above-described save instruction portion 560 is an example of a configuration for instructing the user to save the moving image of the detection accuracy confirmation process, and is not limited thereto. For example, a button for instructing to save the moving image of the detection accuracy confirmation process may be provided in collation result display portion 550 of setting screen 500, and the button may be configured to save the moving image of the detection accuracy confirmation process when the user selects the button.

According to the recorded detection accuracy confirmation process, the user can confirm the detection accuracy of radar 100 during the detection period and the determination result of the success or failure of the detection accuracy afterward. Further, by recording the entire detection accuracy confirmation process, it is possible to provide evidence that the detection accuracy and the determination result of the success or failure of radar 100 are obtained through the appropriate process, and it is possible to suppress forgery and falsification of the detection accuracy and the determination result of the success or failure of radar 100.

### [1-4. Operation of Radar Setting Apparatus]

### [1-4-1. Lane Region Setting Process]

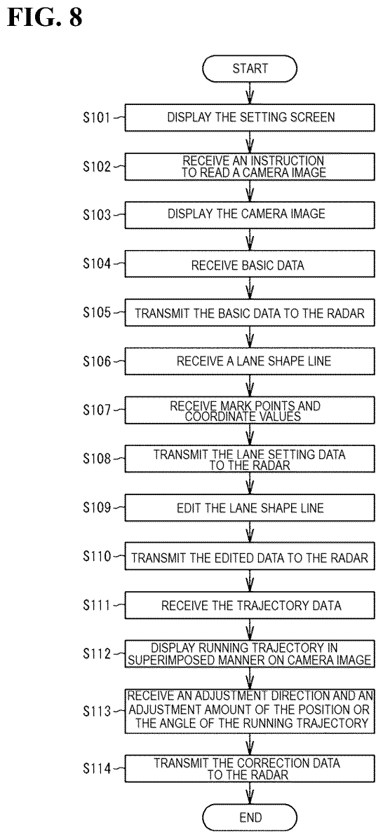

FIG. 8 is a flowchart showing an example of a procedure of lane region setting process of radar setting apparatus 400 according to the first embodiment. When processor 401 activates setting program 409, radar setting apparatus 400 executes lane region setting process as described below.

Processor 401 displays setting screen 500 for lane region setting of radar 100 on display unit 405 (step S101).

The user selects image reading button 511a (see FIG. 5A) to instruct radar setting apparatus 400 to read camera image 521. Processor 401 receives an instruction to read camera image 521 (step S102). Upon receiving the read instruction, processor 401 reads camera image 521 and displays the read camera image 521 on image display portion 520 (step S103).

The user inputs basic data to basic data input portion 512 (see FIG. 5A). Processor 401 receives the input basic data (step S104). Processor 401 transmits the input basic data to radar 100 (step S105). Radar 100 initially sets a lane region in a coordinate system and a coordinate space using the basic data.

The user selects lane drawing instruction button 513a and draws lane shape line 522 on camera image 521 (see FIG. 5A). Processor 401 receives an input of lane shape line 522 (step S106).

The user inputs coordinate values to coordinate input portion 514b, selects mark point input button 514a, and inputs mark points 523a and 523b on camera image 521 (see FIG. 5A). Processor 401 receives inputs of mark points 523a and 523b and coordinate values (step S107).

Processor 401 generates lane setting data from the received lane shape line 522 data, mark points 523a, 523b and coordinate value data, and transmits the lane setting data to radar 100 (step S108). Radar 100 specifies the shape of the lane based on the received lane setting data, and changes the lane region according to the specified shape.

The user selects lane editing button 513b (see FIG. 5A). Upon receiving the selection of lane editing button 513b, processor 401 requests lane region data from radar 100. In response to the request, radar 100 transmits lane region data including the coordinate values of lane regions R1, R2, and R3. When the lane region data is received, processor 401 displays lane shape line 523 indicating the lane line of each of the lanes based on lane regions R1, R2, and R3 in a superimposed manner on camera image 521. The user edits lane shape line 523 by moving node 523c of lane shape line 523 (step S109). Processor 401 generates edit data defining the edited lane regions R1, R2, and R3 according to the edited lane shape line 523, and transmits the edited data to radar 100 (step 110). Radar 100 changes the settings of lane regions R1, R2, and R3 according to the edited data.

Radar 100 generates trajectory data from the time-series position data of detected vehicle V and transmits the trajectory data to radar setting apparatus 400. Radar setting apparatus 400 receives the trajectory data (step S111). Processor 401 displays running trajectory 524 (see FIG. 5F) of vehicle V in a superimposed manner on camera image 521 based on the received trajectory data (step S112).

The user adjusts the position or angle of running trajectory 524 to fit into the lanes in camera image 521 using at least one of enlarge button 515a, reduce button 515b, move up button 515c, move down button 515d, move right button 515e, move left button 515f, clockwise button 515g, counterclockwise button 515h, front rotation button 515i, and back rotation button 515j in lane adjustment portion 515. Processor 401 receives an adjustment direction and an adjustment amount of the position or the angle of running trajectory 524 (step S113).

Processor 401 generates correction data from the received adjustment direction and adjustment amount of the coordinates of running trajectory 524, and transmits the correction data to radar 100 (step S114). Radar 100 adjusts a position and an angle of the lane region in the coordinate space based on the received correction data. This completes the lane region setting process.

[1-4-2. Detection Accuracy Confirmation Process]

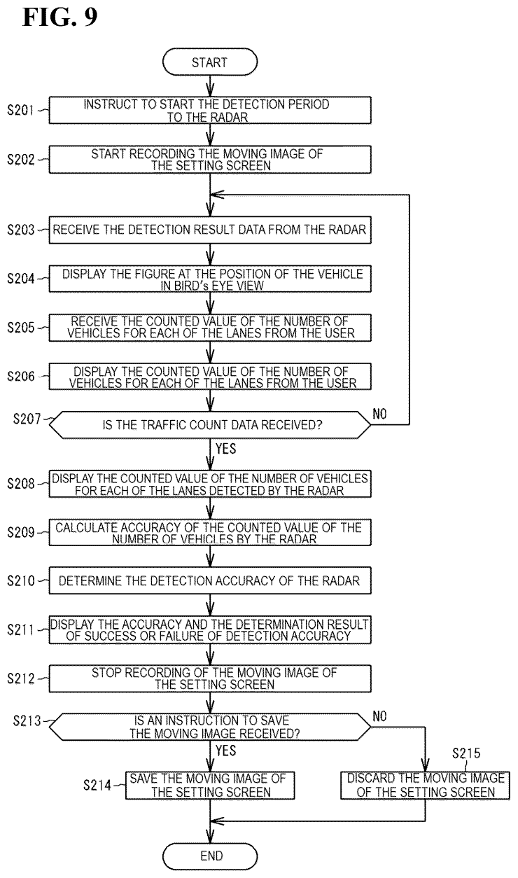

FIG. 9 is a flowchart showing an example of a procedure of a detection accuracy confirmation process of radar setting apparatus 400 according to the first embodiment. When the lane region setting of radar 100 is completed, radar setting apparatus 400 executes a lane region setting process as described below.

The user selects log start button 551 in setting screen 500 and gives an instruction to start recording to radar setting apparatus 400. Upon receiving the recording start instruction, processor 401 transmits an instruction to start the detection period to radar 100 (step S201). Upon receiving the instruction to start the detection period, radar 100 starts the detection period. Processor 401 starts recording the detection accuracy confirmation process, i.e., recording the moving image of setting screen 500 (step S202).

Radar 100 detects the position of vehicle V during the detection period, counts the number of vehicles for each of the lanes, and generates a traffic count data. Radar 100 transmits traffic count data each time the detection period ends.

In parallel with the counting of the number of vehicles, radar 100 detects the position of vehicle V running in measurement area 300 in real time and sequentially transmits the detection result data. Radar setting apparatus 400 receives the detection result data transmitted from radar 100 (step S203). Based on the received detection result data, processor 401 displays FIG. 542 at the position of the detected vehicle V in bird's eye view display portion 540 (see FIG. 5A) (step S204). The display of FIG. 542 in bird's eye view display portion 540 is updated in real time each time the detection result data is received.

The user visually observes measurement area 300 or confirms camera image 521 of the imaged measurement area 300, and counts the number of vehicles for each of the lanes in measurement area 300. The user inputs the number of vehicles for each of the lanes into radar setting apparatus 400 using count portions 532a, 533a, 532b, 533b, 532c, 533c, 532d, and 533d (see FIG. 5A). For example, the user confirms the scheduled receiving time of the next traffic count data displayed on scheduled receiving time display portion 535b and the receiving interval of the traffic count data displayed on receiving interval display portion 535c, starts counting the number of vehicles for each of the lanes when the scheduled receiving time arrives, and ends counting the number of vehicles for each of the lanes when the receiving interval elapses. Thus, the user can count the number of vehicles for each of the lanes during the detection period.

During the detection period, processor 401 receives an input of the counted value of the number of vehicles for each of the lanes from the user (step S205). Processor 401 displays the input counted values in counted value display portions 534a, 534b, 534c, and 534d (see FIG. 5A) (step S206).

Processor 401 determines whether or not the traffic count data transmitted from radar 100 has been received (step S207). If no traffic count has been received (NO in step S207), processor 401 returns to step S203.

The input of the counted value from the user is continued until the detection period ends, and the display of the counted value on counted value display portions 534a, 534b, 534c, and 534d is updated in real time until the detection period ends.

If the traffic count data is received (YES in step S207), processor 401 displays the counted value of the number of vehicles for each of the lanes in first count result display portion 531 (see FIG. 5A) based on the received traffic count data (step S208).

The user can confirm the detection accuracy of radar 100 by comparing the counted value displayed on first count result display portion 531 with the counted value displayed on second count result display portion 532.

The user can also confirm the detection accuracy of radar 100 by comparing the position of the detected vehicle displayed on bird's eye view display portion 540 with the position of vehicle V running in measurement area 300 confirmed with the naked eye or the position of vehicle V shown in camera image 521. Note that the reception of the detection data and the update of the position of the detected vehicle in bird's eye view display portion 540 may be continued even after the detection period ends.

Processor 401 collates the counted value of the number of vehicles for each of the lanes indicated by the traffic count data with the counted value of the number of vehicles for each of the lanes input by the user, and calculates the accuracy of the counted value of the number of vehicles by radar 100 (step S209). Processor 401 compares the calculated accuracy with a reference value, and determines the success or failure of the detection accuracy (step S210). Processor 401 displays the accuracy and the determination result of the success or failure of the detection accuracy in collation result display portion 550 (see FIG. 5H) (step S211). The user can easily confirm whether or not radar 100 has sufficient detection accuracy by confirming the accuracy and the determination result of the success or failure of the selection accuracy displayed on collation result display portion 550.

Processor 401 stops recording of the detection accuracy confirmation process, that is, recording of the moving image of setting screen 500 (step S212). Processor 401 displays save instruction portion 560. The user selects save instruction button 561 to save the moving image of the detection accuracy confirmation process, and selects cancel button 562 to discard the moving image of the detection accuracy confirmation process. When save instruction button 561 is selected and an instruction to save the moving image of the detection accuracy confirmation process is input (YES in step S213), processor 401 saves the moving image of setting screen 500 (step S214). When an instruction to discard the moving image of the detection accuracy confirmation process is input (NO in step S213), processor 401 discards the moving image of setting screen 500 (step S215). This completes the detection accuracy confirmation process.

### 2. SECOND EMBODIMENT

In the present embodiment, radar setting apparatus 400 recognizes the vehicle by subjecting the read camera image 521 to a process and automatically counts the number of vehicles for each of the lanes. That is, in the present embodiment, the image recognition process on camera image 521 is the “means different from the infrastructure sensor”. When the detection period starts, processor 401 of radar setting apparatus 400 (see FIG. 3) performs an image recognition process on camera image 521 to detect the image of the vehicle. Processor 401 determines in which lane the vehicle is running based on the position of the detected image of the vehicle, and counts the number of vehicles for each of the lanes. When the detection period ends, processor 401 ends counting the number of vehicles.

In the present embodiment, the count result of the number of vehicles by image processing is displayed on second count result display portion 532. The user can confirm the detection accuracy of radar 100 by comparing the counted value of the vehicle detected by radar 100 with the counted value of the vehicle obtained by the image recognition process.

In the present embodiment, collation unit 423 (see FIG. 4) collates the number of vehicles detected by radar 100 during the detection period with the number of vehicles running in measurement area 300 counted during the detection period by the image recognition process. Collation unit 423 calculates the accuracy of the counted value of the number of vehicles by radar 100 using the counted value of the number of vehicles by the image recognition process as a true value. Collation unit 423 compares the accuracy with a predetermined reference value and determines whether the detection accuracy of radar 100 is the success or failure. Setting screen display unit 411 displays the accuracy and the determination result of the success or failure of the detection accuracy in collation result display portion 550.

### 3. THIRD EMBODIMENT

In the present embodiment, setting screen 500 is not provided with second count result display portion 532. In the present embodiment, camera image 521 is the “reference information” and image display portion 520 is the “second result display portion”. That is, the user refers to camera image 521 displayed on image display portion 520 and compares the counted value of the number of vehicles for each of the lanes displayed on first count result display portion 531 with the number of vehicles for each of the lanes displayed on camera image 521. Thus, the user can confirm the detection accuracy of the radar.

### 4. FOURTH EMBODIMENT

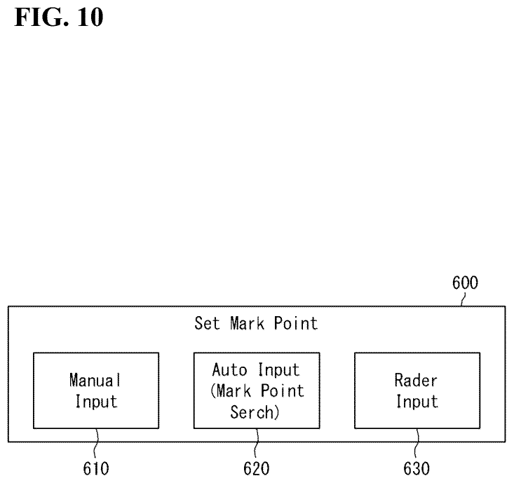

In the present embodiment, a user can select a mark point input method. Reference is made to FIG. 5A. In the present embodiment, mark point input button 514a is a button for the user to select a mark point input method. When mark point input button 514a is selected by the user, a select portion 600, which is a window for selecting a mark point, is displayed. FIG. 10 is a diagram showing an example of select portion 600. Select portion 600 includes a manual input button 610, an automatic input button 620, and a radar input button 630.

Manual input button 610 is a button for the user to select manual input as a mark point input method. When manual input button 610 is selected by the user, the user can input mark points 523a and 523b in image display portion 520 as in the first embodiment.

Automatic input button 620 is a button for the user to select automatic input of a mark point by an image recognition process as a mark point input method. When automatic input button 620 is selected by the user, processor 401 performs an image recognition process on camera image 521 to recognize road components, for example, lane lines, road markings (crosswalks, stop lines, regulatory markings, etc.), road signs, etc. Processor 401 sets a feature point (for example, an end point of a white line) of the recognized component as a mark point. Thus, the mark point is automatically input.

A feature point recognized in camera image 521 may be set as a candidate point of the mark point. It is preferable that there are a plurality of candidate points. In image display portion 520, candidate points are displayed so as to be superimposed on camera image 521. The candidate point can be selected by the user using input apparatus 406, and the selected candidate point is set as the mark point. The user enters the mark point by selecting a candidate point.

Radar input button 630 is a button for the user to select an input of a mark point detected by radar 100 as a mark point input method. When radar input button 630 is selected by the user, radar 100 detects an object installed in the vicinity of the road, for example, a road sign, a marker installed on the road side or on the road, or the like. Radar 100 transmits mark point data including the detected object position information to radar setting apparatus 400. When radar setting apparatus 400 receives the mark point data, the mark point is input.

As described above, the mark point input by the selected input method is displayed so as to be superimposed on camera image 521. The user inputs the coordinate values of the mark point to coordinate input portion 514b. Accordingly, the mark point and the coordinate value are provided to radar setting apparatus 400.

### 5. FIFTH EMBODIMENT

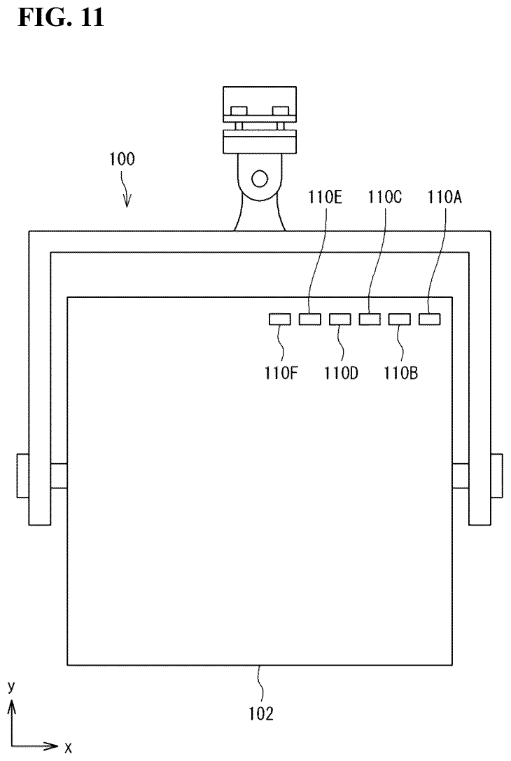

FIG. 11 is a diagram showing an example of a back surface of a radar according to a fifth embodiment. A plurality of Light Emitting Diodes (LEDs) 110A, 110B, 110C, 110D, 110E, and 110F are provided on the upper portion of the back surface of the housing of radar body 102. LEDs 110A, 110B, 110C, 110D, 110E, and 110F are capable of emitting light in different colors from each other. For example, LED 110A can emit red light, LED 110B can emit orange light, LED 110C can emit yellow light, LED 110D can emit yellow green light, LED 110E can emit green light, and LED 110F can emit blue light.

The housing of radar body 102 is waterproof. For example, the housing of radar body 102 is covered with a waterproof cover made of synthetic resin. The waterproof cover is made of a light transmissible material (for example, transparent or translucent). Accordingly, an installation worker of radar 100 can visually recognize the light emission of LEDs 110A, 110B, 110C, 110D, 110E, and 110F through the waterproof cover.

Each of LEDs 110A, 110B, 110C, 110D, 110E, and 110F emits light according to a detection distance of an object (vehicle V) by radar 100. That is, each of LEDs 110A, 110B, 110C, 110D, 110E, and 110F is turned on when the detected distance is within the specific range, and is turned off when the detected distance is out of the range. Accordingly, by confirming the light emission state of LEDs 110A, 110B, 110C, 110D, 110E, and 110F, the installation worker can easily confirm whether or not radar 100 detects vehicle V, and can easily confirm the distance from radar 100 to vehicle V.

As shown in FIG. 11, the lateral direction of the outer periphery of the back surface of the rectangular radar body 102 is defined as the x direction, and the direction orthogonal to the x direction is defined as the y direction. LEDs 110A, 110B, 110C, 110D, 110E, and 110F are arranged in a line in the x direction on the back surface of radar body 102. The position in the x-direction corresponds to the distance from radar 100. The LED located further to the right in FIG. 11 has a larger corresponding distance. Each of LEDs 110F, 110E, 110D, 110C, 110B, and 110A is preset to correspond to a specific range defined by a distance from radar 100. For example, LED 110A corresponds to a range that is equal to or less than distance 200 m from radar 100 and equal to or more than distance 190 m from radar 100. Similarly, LED 110B corresponds to a range of 175 m to 185 m, LED 110C corresponds to a range of 155 m to 165 m, LED 110D corresponds to a range of 130 m to 140 m, LED 110E corresponds to a range of 100 m to 110 m, and LED 110F corresponds to a range of 65 in to 75 m. Each of LEDs 110A, 110B, 110C, 110D, 110E, and 110F emits light during a period in which the distance from radar 100 to vehicle V detected by radar 100 falls within a corresponding range (threshold range). Accordingly, for example, after installing radar 100, an installation worker of radar 100 can easily confirm the detection accuracy of radar 100 by confirming the light emission state of LEDs 110A, 110B, 110C, 110D, 110E, and 110F while visually confirming vehicle V running in measurement area 300, and can easily determine whether or not the installation angle of radar 100 is appropriate. Note that the term “detection accuracy” as used herein includes both the meanings of “accuracy” and “variation”. For example, “accuracy” can be confirmed by setting the result of visual vehicle detection by the installation worker as a true value and confirming whether or not the detection result of radar 100 is close to the true value. For example, by repeatedly comparing the vehicle detection result by visual observation and the vehicle detection result by radar 100, it is possible to confirm whether or not there is variation in the detection result by radar 100.

Furthermore, by making the emission colors of LEDs 110A, 110B, 110C, 110D, 110E, and 110F different from each other, the installation worker can easily confirm in which range vehicle V is detected.

Hereinafter, “range” described in one paragraph above is referred to as a “distance range”. The difference between the lower limit value 190 m of the distance range corresponding to LED 110A and the upper limit value 185 m of the distance range corresponding to LED 110B is 5 m. The difference between the lower limit value 175 m of the distance range corresponding to LED 110B and the upper limit value 165 m of the distance range corresponding to LED 110C is 10 m. The difference between the lower limit value 155 m of the distance range corresponding to LED 110C and the upper limit value 140 m of the distance range corresponding to LED 110D is 15 m. The difference between the lower limit value 130 m of the distance range corresponding to LED 110D and the upper limit value 110 m of the distance range corresponding to LED 110E is 20 m. The difference between the lower limit value 100 m of the distance range corresponding to LED 110E and the upper limit value 75 m of the distance range corresponding to LED 110F is 25 m. As described above, the distance range corresponding to each of LEDs 110A, 110B, 110C, 110D, 110E, and 110F is set to be shorter as the distance from radar 100 increases, and to be longer as the distance from radar 100 decreases. In the angle setting of radar 100, as the distance from radar 100 increases, even a slight deviation of the angle greatly affects the detection result. Therefore, the angle of radar 100 can be set more accurately by using the detection result at a long distance than by using the detection result at a short distance. By setting the distance ranges of LEDs 110A, 110B, 110C, 110D, 110E, and 110F as described above, the installation worker can confirm in detail the detection result of radar 100 at a long distance from radar 100, and can easily confirm whether or not the installation angle of radar 100 is appropriate.

However, the above-described distance range is an example, and is not limited thereto. For example, the distance range of each of LEDs 110A, 110B, 110C, 110D, 110E, and 110F can be set to the same value among the LEDs. Accordingly, the installation worker can confirm the detection accuracy in the same distance range by any of LEDs 110A, 110B, 110C, 110D, 110E, and 110F regardless of the distance from radar 100.

For example, LEDs 110A, 110B, 110C, 110D, 110E, and 110F may correspond to the distance range set at 10 m interval at 150 m or farther from radar 100. As a result, the installation worker can confirm the detection accuracy at 150 m or farther, which is relatively long distance from radar 100.

As another example, LEDs 110A, 110B, 110C, 110D, 110E, and 110F can correspond to a distance range at a relatively short distance from radar 100 (e.g., up to 100 m from radar 100). In this case, if the distance from the radar 100 is long, the distance range can be set small, if the distance from the radar 100 is short, the distance range can be set large (for example, the distance range is set by 5 m interval or the like in the distance of 70 m to 100 m from radar 100, and the distance range is set by 10 m interval in the distance of less than 70 m from radar 100).

Although the distance range corresponding to each of LEDs 110A, 110B, 110C, 110D, 110E, and 110F is set as the range of 10 m, the range is not limited thereto. The distance range can be set according to the speed limit on the road of measurement area 300. For example, in radar 100 installed on an expressway having a speed limit of 100 km/h, the distance range can be set to 10 m, and in radar 100 installed on a general road having a speed limit of 50 km/h, the distance range can be set to 5 m.

For example, the distance range may be set according to the detection cycle of radar 100. Vehicle V running at 120 km/h runs 3.3 m in 100 ms (milliseconds). Vehicle V running at 80 km/h runs 2.2 m in 100 ms. In a case where the detection cycle of radar 100 is 100 ms, when the distance range is set to be equal to or less than 3 m, there is a possibility that the LED does not emit light even if vehicle V of 120 km/h is detected. Similarly, when the distance range is set to be equal to or less than 2 m, there is a possibility that the LED does not emit light even if vehicle V of 80 km/h is detected. Therefore, the distance range may be set to a length through which vehicle V running at the speed limit passes in a period longer than the detection cycle of radar 100.

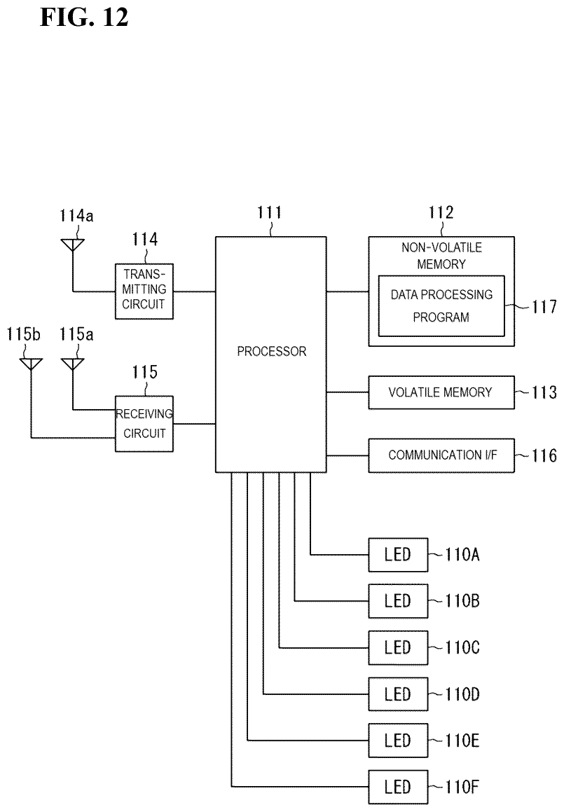

FIG. 12 is a block diagram showing an example of an internal configuration of a radar according to a fifth embodiment. Radar 100 includes a processor 111, a non-volatile memory 112, a volatile memory 113, a transmitting circuit 114, a receiving circuit 115, and a communication interface (communication I/F) 116.

Volatile memory 113 is a semiconductor memory such as an SRAM, a DRAM etc. Non-volatile memory 112 is, for example, a flash memory, a hard disk, a ROM, or the like. Non-volatile memory 112 stores a data processing program 117, which is a computer program, and data used for executing data processing program 117. Radar 100 is configured to include a computer, and each function of radar 100 is performed by processor 111 executing data processing program 117, which is a computer program stored in a storage apparatus of the computer. Data processing program 117 can be stored in a recording medium such as a flash memory, a ROM, or a CD-ROM. Processor 111 executes data processing program 117 and causes LEDs 110A, 110B, 110C, 110D, 110E, and 110F to emit light in accordance with the detection distance of vehicle V by radar 100 as will be described later.

Processor 111 is, for example, a CPU. However, processor 111 is not limited to the CPU. Processor 111 may be a GPU. Processor 111 may be, for example, an ASIC or a programmable logic device such as a gate array or an FPGA. In this case, the ASIC or the programmable logic device is configured to be able to execute the same processing as data processing program 117.

Transmitting circuit 114 includes a transmitting antenna 114a. Transmitting circuit 114 generates a modulated wave and transmits the generated modulated wave from transmitting antenna 114a. The transmitted modulated wave hits an object (e.g., vehicle V) and is reflected.

Receiving circuit 115 includes receiving antennas 115a and 115b. Receiving antennas 115a and 115b receive a reflected wave from vehicle V. Receiving circuit 115 performs signal processing on the received reflected wave. The reflected wave data generated by the signal processing is provided to processor 111. Processor 111 analyzes the reflected wave data and detects a distance and an angle (position), and a speed of vehicle V with respect to radar 100.

The communication I/F 116 can communicate with an external apparatus in a wired or wireless manner. The communication I/F 116 can transmit information of vehicle V detected by radar 100 to an external apparatus (e.g., radar setting apparatus 400).

Each of LEDs 110A, 110B, 110C, 110D, 110E, and 110F is connected to processor 111 by a signal line. Processor 111 can control LEDs 110A, 110B, 110C, 110D, 110E, and 110F.

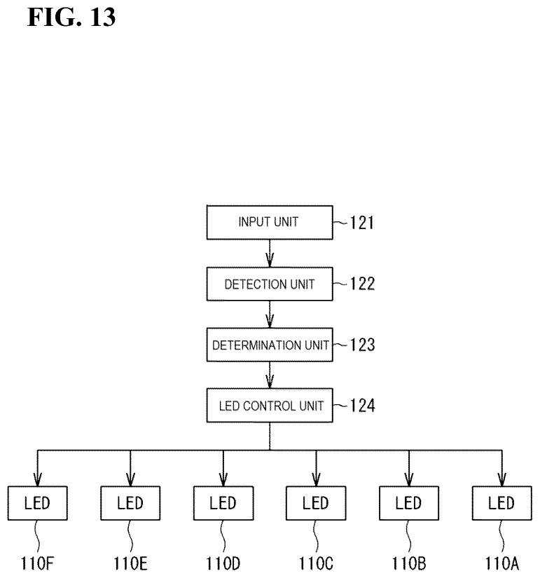

FIG. 13 is a functional block diagram showing an example of a functions of radar 100 according to the fifth embodiment. When processor 111 executes data processing program 117, radar 100 performs functions of an input unit 121, a detection unit 122, a determination unit 123, and an LED control unit 124.

Input unit 121 receives the reflected wave data generated by receiving circuit 115.

Detection unit 122 performs analysis processing on the reflected wave data received by input unit 121, and detects the distance to vehicle V in measurement area 300, the angle of vehicle V with respect to radar 100, and the speed of vehicle V.

Determination unit 123 compares the distance detection value obtained by detection unit 122 with the threshold range of the distance associated with each of LEDs 110A, 110B, 110C, 110D, 110E, and 110F, and determines whether or not the distance detection value falls within the threshold range. That is, determination unit 123 determines whether or not the distance detection value falls within the threshold range for each of the plurality of threshold ranges.

LED control unit 124 controls LEDs 110A, 110B, 110C, 110D, 110E, and 110F based on the determination result by determination unit 123. When the distance detection value is within the threshold range corresponding to LED 110A, LED control unit 124 causes LED 110A to emit light. Similarly, for LEDs 110B, 110C, 110D, 110E, and 110F, LED control unit 124 causes LEDs 110B, 110C, 110D, 110E, and 110F whose distance detection values fall within the corresponding threshold range to emit light.

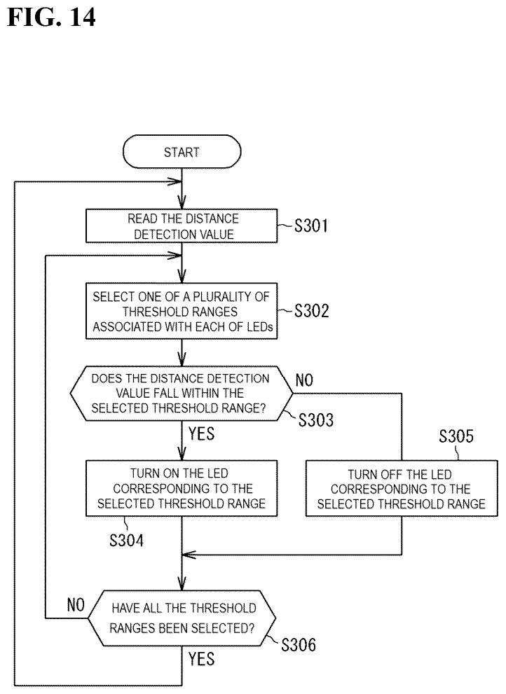

Next, the operation of radar 100 will be described. Processor 111 executes the LED light emission control process by activating data processing program 117. FIG. 14 is a flowchart showing an example of a procedure of LED light emission control processing by a radar according to the fifth embodiment.

When data processing program 117 is activated, all of LEDs 110A, 110B, 110C, 110D, 110E, and 110F are turned off.

When vehicle V runs in measurement area 300, the modulated wave transmitted from transmitting antenna 114a is reflected by vehicle V, and the reflected wave is received by receiving antennas 115a and 115b. Analysis processing is performed on the reflected wave data, and detection values of the distance, the angle, and the speed of vehicle V with respect to radar 100 are obtained. The obtained detection values of the distance, the angle, and the speed are stored in non-volatile memory 112 or volatile memory 113.

Processor 111 reads the distance detection value from non-volatile memory 112 or volatile memory 113 (step S301).

Processor 111 selects one of a plurality of threshold ranges associated with each of LEDs 110A, 110B, 110C, 110D, 110E, and 110F (step S302). Processor 111 determines whether or not the distance detection value falls within the selected threshold range (step S303).

When the distance detection value falls within the selected threshold range (YES in step S303), processor 111 turns on the LED corresponding to the threshold range (step S304). Note that the lighting time of the LED may be set to any time that is easy to see.

When the distance detection value does not fall within the selected threshold range (NO in step S303), processor 111 turns off the corresponding LED (step S305). As a result, the LEDs that have been turned on in the previous processing cycle stop emitting light, and the LEDs that have not been turned on in the previous processing cycle maintain non-emission.

Processor 111 determines whether or not all the threshold ranges have been selected (step S306). If unselected threshold ranges remain (NO in step S306), processor 111 returns to step S302 and selects one of the unselected threshold ranges. When all the threshold ranges have been selected (YES in step S306), processor 111 returns to step S301 and reads the latest distance detection value.

With the configuration of radar 100 as described above, when vehicle V runs in measurement area 300, the LED corresponding to the position of vehicle V emits light. In measurement area 300, when vehicle V is running in a direction approaching radar 100, the light emission of LEDs 110A, 110B, 110C, 110D, 110E, and 110F transitions in this order. When vehicle V is running in a direction away from radar 100 in measurement area 300, the light emission of LEDs 110F, 110E, 110D, 110C, 110B, and 110A transitions in this order. When a plurality of vehicles V run in measurement area 300, one or more of LEDs 110A, 110B, 110C, 110D, 110E, and 110F emit light.

In the fifth embodiment described above, the plurality of LEDs 110A, 110B, 110C, 110D, 110E, and 110F are arranged on the back surface of the housing of radar body 102, but the present disclosure is not limited thereto. For example, one multi-color light-emitting LED may be arranged on the back surface of the housing of radar body 102, and the LED may emit light in a color corresponding to the distance detection value. For example, red corresponds to a threshold range of 190 m to 200 m, orange corresponds to a threshold range of 175 in to 185 m, yellow corresponds to a threshold range of 155 in to 165 m, yellow-green corresponds to a threshold range of 130 m to 140 m, green corresponds to a threshold range of 100 m to 110 m, and blue corresponds to a threshold range of 65 m to 75 m.

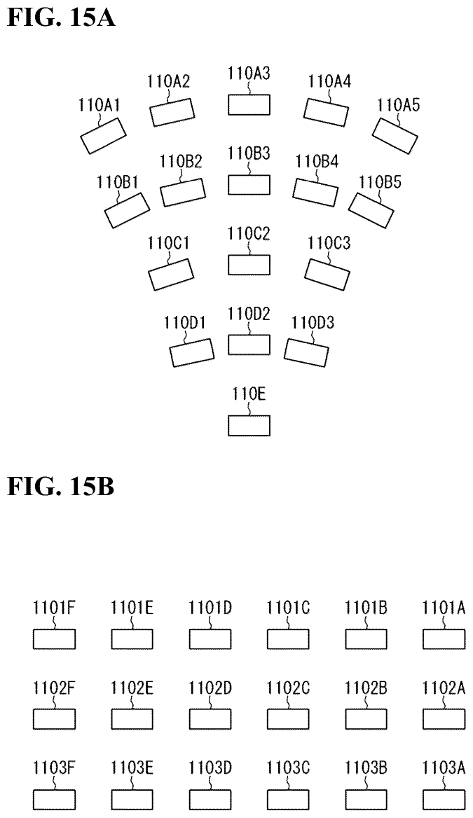

Modifications of radar 100 according to the present embodiment are described below. FIG. 15A is a diagram showing a first modification of an arrangement of LEDs in radar 100. As shown in FIG. 15A, a plurality of LEDs may be arranged in a fan shape. In the fan shape formed by the plurality of LEDs, the radial direction corresponds to the distance from radar 100 and the circumferential direction corresponds to the angle. LEDs 110A1, 110A2, 110A3, 110A4, and 110A5 forming the arc row correspond to the same distance range (for example, a distance range of 190 m to 200 m from radar 100). LEDs 110B1, 110B2, 110B3, 110B4, and 110B5 forming the arc row correspond to the same distance range (for example, a distance range of 175 m to 185 m from radar 100). LEDs 110C1, 110C2, and 110C3 forming the arc row correspond to the same distance range (for example, a distance range of 155 m to 165 m from radar 100). LEDs 110D1, 110D2, and 110D3 forming the arc row correspond to the same distance range (for example, a distance range of 130 m to 140 m from radar 100). One LED 110E corresponds to, for example, a distance range of 100 in to 110 m.

LEDs 110A1, 110A2, 110A3, 110A4, and 110A5 forming the arc rows correspond to angle ranges different from each other. For example, LED 110A1 corresponds to an angular range of −10° to −7°, LED 110A2 corresponds to an angular range of −7° to −3°, LED 110A3 corresponds to an angular range of −3° to +3°, LED 110A4 corresponds to an angular range of +3° to +7°, and LED 110A5 corresponds to an angular range of +7° to +10°. The angle with respect to radar 100 is 0° when facing radar 100, and the left side as viewed from radar 100 is negative and the right side as viewed from radar 100 is positive.

Similarly, LEDs 110B1, 110B2, 110B3, 110B4, and 110B5 forming the arc rows correspond to different angular ranges from each other. LEDs 110C1, 110C2, and 110C3 forming the arc rows also correspond to different angular ranges from each other, and LEDs 110D1, 110D2, and 110D3 forming the arc rows also correspond to different angular ranges from each other. For example, five LEDs 110B1, 110B2, 110B3, 110B4, and 110B5 correspond to the same five angular ranges as LEDs 110A1, 110A2, 110A3, 110A4, and 110A5 described above. For example, LED 110C1 and LED 11D1 correspond to an angular range of −10° to −3°, LED 110C2 and LED 11D2 correspond to an angular range of −3° to +3°, and LED 110C3 and LED 11D3 correspond to an angular range of +3° to +10°.

For example, LEDs 110A1, 110A2, 110A3, 110A4, 110A5 forming the arc rows emit light of the same color, LEDs 110B1, 110B2, 110B3, 110B4, 110B5 forming the arc rows emit light of the same color, LEDs 110C1, 110C2, 110C3 forming the arc rows emit light of the same color, and LEDs 110D1, 110D2, 110D3 forming the arc rows emit light of the same color. The light emission colors of the LEDs are different from each other for each of the arc rows. That is, the emission color of the LED is different for each corresponding distance range. However, such a combination of emission colors is merely an example, and the present disclosure is not limited thereto.

Processor 111 obtains the distance detection value and the angle detection value of vehicle V by radar 100, determines whether or not the distance detection value falls within the distance threshold range for each distance threshold range, and determines whether or not the angle detection value falls within the angle threshold range for each angle threshold range. Processor 111 turns on the LED corresponding to the distance threshold range and the angle threshold range within which the distance detection value and the angle detection value fall.

Thereby, the LED corresponding to the distance and angle at which vehicle V is detected emits light. With such a configuration, the installation worker can confirm not only the distance detection accuracy but also the angle detection accuracy of radar 100.

FIG. 15B is a diagram showing a second modification of an arrangement of LEDs in radar 100. As shown in FIG. 15B, a plurality of LEDs may be arranged to form a plurality of rows. Each row corresponds to a plurality of lanes in measurement area 300. In other words, LEDs 1101A, 1101B, 1101C, 1101D, 1101E, and 1101F correspond to the first lane, LEDs 1102A, 1102B, 1102C, 1102D, 1102E, and 1102F correspond to the second lane, and LEDs 1103A, 1103B, 1103C, 1103D, 1103E and 1103F correspond to the third lane. Here, the colors of LEDs can be made different for each of the lanes. For example, LEDs 1101A, 1101B, 1101C, 1101D, 1101E, and 1101F corresponding to the first lane can be red, LEDs 1102A, 1102B, 1102C, 1102D, 1102E, and 1102F corresponding to the second lane can be yellow, and LEDs 1103A, 1103B, 1103C, 1103D, 1103E and 1103F corresponding to the third lane can be blue. Accordingly, it is possible to easily distinguish the detection result of vehicle V for each of the lanes.

LEDs 1101A, 1101B, 1101C, 1101D, 1101E, 1101F forming the row correspond to different distance ranges from each other. The LED located further to the right in FIG. 15B has a larger corresponding distance. That is, the corresponding distance increases in the order of LEDs 11011F, 1101E. 1101D, 1101C, 1101B, and 1101A. Similarly, LEDs 1102A, 1102B, 1102C, 1102D, 1102E, 1102F and LEDs 1103A, 1103B, 1103C, 1103D, 1103E and 1103F forming the row are arranged such that the corresponding distance increases toward the right.

For example, LEDs emit different colors depending on the corresponding distance range. LEDs corresponding to the same distance range emit light in the same color. For example, LEDs 1101A, 1102A, and 1103A can emit red light, LEDs 1101B, 1102B, and 1103B can emit orange light, LEDs 1101C, 1102C, and 1103C can emit yellow light, LEDs 1101D, 1102D, and 1103D can emit yellow-green light, LEDs 1101E, 1102E, and 1103E can emit green light, and LEDs 1101F, 1102F, and 1103F can emit blue light. However, such a combination of emission colors is merely an example, and the present disclosure is not limited thereto.

Processor 111 specifies the lane in which detected vehicle V runs based on the distance detection value and the angle detection value of vehicle V by radar 100. Processor 111 determines, for each distance threshold range, whether or not the distance detection value falls within the distance threshold range. Processor 111 turns on the LED corresponding to the specified lane and the distance threshold range within which the distance detection value falls.

As a result, the LED corresponding to the lane and the distance in which vehicle V is detected emits light. With such a configuration, the installation worker can confirm the detection accuracy of the distance of radar 100 for each of the lanes.

### 6. SIXTH EMBODIMENT

Radar 100 according to the present embodiment causes an LED corresponding to the number of vehicles detected by radar 100 to emit light. The threshold range corresponding to each of LEDs 110A, 110B, 110C, 110D, 110E, and 110F is different from each other. For example, LEDs 110A, 110B, 110C, 110D, 110E, and 110F are associated with the threshold range of the number of vehicles instead of the threshold range of distance. For example, LED 110F corresponds to one or more vehicles and less than five vehicles, LED 110E corresponds to five or more vehicles and less than 10 vehicles, LED 110D corresponds to 10 or more vehicles and less than 15, LED 110C corresponds to 15 or more vehicles and less than 20 vehicles, LED 110B corresponds to 20 vehicles and less than 25 vehicles, and LED 110A corresponds to 25 or more vehicles and less than 30 vehicles. Since the configuration of radar 100 according to the present embodiment is the same as the configuration of radar 100 according to the fifth embodiment, the description thereof is omitted.

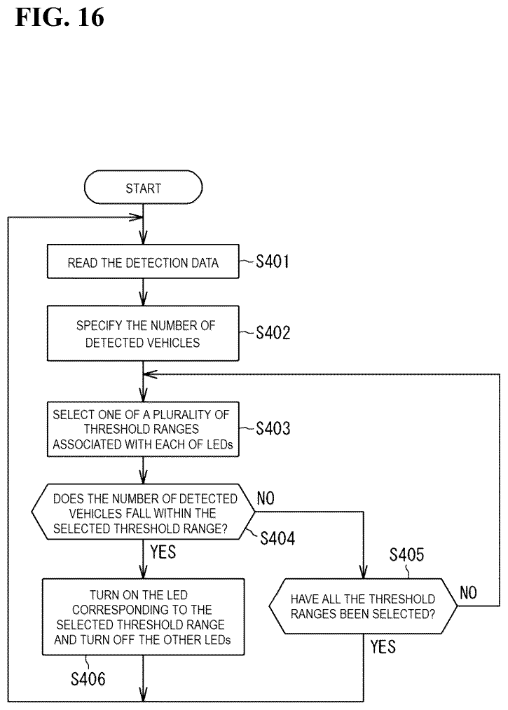

The operation of radar 100 according to the present embodiment will now be described. FIG. 16 is a flowchart showing an example of a procedure of LED light emission control processing by a radar according to the sixth embodiment.

When data processing program 117 is activated, all of LEDs 110A, 110B, 110C, 110D, 110E, and 110F are turned off.

Detection data indicating detection results (a distance detection value, an angle detection value, and a speed detection value) for each vehicle by radar 100 is stored in non-volatile memory 112 or volatile memory 113. Processor 111 reads the detection data from non-volatile memory 112 or volatile memory 113 (step S401). Processor 111 specifies the number of detected vehicles V (the number of vehicles detected) based on the obtained detection data (step S402).

Processor 111 selects one of a plurality of threshold ranges associated with each of LEDs 110A, 110B, 110C, 110D, 110E, and 110F (step S403). Processor 111 determines whether or not the number of vehicles detected falls within the selected threshold range (step S404).

When the number of vehicles detected does not fall within the selected threshold range (NO in step S404), processor 111 determines whether or not all threshold ranges have been selected (step S405). If unselected threshold ranges remain (NO in step S405), processor 111 returns to step S403 and selects one of the unselected threshold ranges. When all the threshold ranges have been selected (YES in step S405), processor 111 returns to step S401 and reads the latest detection data.

When the number of vehicles detected falls within the selected threshold range (YES in step S404), processor 111 turns on the LED corresponding to the threshold range and turns off the other LEDs (step S405). When the LED turned on in the previous processing cycle and the LED turned on this time are the same, the LED turned on maintains light emission and the other LEDs maintain non-light emission. When the LED turned on in the previous processing cycle is different from the LED to be turned on this time, the LED to be turned on is switched.

After step S405, processor 111 returns to step S401 and reads out the latest detection data.

With the configuration of radar 100 as described above, the LEDs corresponding to the number of the vehicles V in measurement area 300 emit light. The installation worker can confirm the detection accuracy of radar 100 by visually confirming the number of vehicles in measurement area 300 and comparing it with the number of vehicles corresponding to the LED that is emitting light.

In the above-described sixth embodiment, the plurality of LEDs 110A, 110B, 110C, 110D, 110E, and 110F are arranged on back surface of the housing of radar body 102, but the present disclosure is not limited thereto. For example, one multi-color light-emitting LED may be arranged on the back surface of the housing of radar body 102, and the LED may emit light in a color corresponding to the number of vehicles detected. For example, blue corresponds to the threshold range of one or more vehicles and less than five vehicles, green corresponds to the threshold range of five or more vehicles and less than 10 vehicles, yellow-green corresponds to the threshold range of 10 or more vehicles and less than 15 vehicles, yellow corresponds to the threshold range of 15 or more vehicles and less than 20 vehicles, orange corresponds to the threshold range of 20 or more vehicles and less than 25 vehicles, and red corresponds to the threshold range of 25 or more vehicles and less than 30 vehicles.

### 7. EFFECTS

Radar setting apparatus 400 according to an embodiment includes display unit 405. Display unit 405 displays setting screen (confirmation screen) 500. Setting screen 500 is a screen including a vehicle detection result by the radar (infrastructure sensor) 100 that transmits a radio wave to measurement area 300, receives a reflected wave reflected by vehicle V, and detects vehicle V in measurement area 300. Setting screen 500 includes first count result display portion (first result display portion) 531 and a second result display portion. First count result display portion 531 displays the number of the vehicles V detected by radar 100 during a predetermined detection period. The second result display portion displays reference information indicating the number of the vehicles obtained during the detection period by means different from radar 100. Accordingly, the user can confirm the detection accuracy of radar 100 by comparing the number of the vehicles detected by radar 100 with the reference information.

The reference information may be camera image 521 obtained by camera 107 configured to photograph measurement area 300 during the detection period. Accordingly, it possible to count the number of the vehicles included in camera image 521 and to compare the count result with the number of the vehicles detected by radar 100.

Radar setting apparatus 400 may further include collation unit 423. Collation unit 423 collates the number of the vehicles detected by radar 100 during the detection period with the number of the vehicles recognized by subjecting camera image 521 to the image recognition process. Accordingly, the number of the vehicles detected by radar 100 can be collated with the number of the vehicles recognized from camera image 521.

The reference information may be the number of the vehicles having passed a specific spot (for example, a vehicle sensing line set at a specific point on a road) in measurement area 300 during the detection period, which is input by the user. Accordingly, the user can count the number of the vehicles having passed the specific spot in measurement area 300 during the detection period, and compare the number of the vehicles detected by radar 100 with the count result.

The second result display portion may include count portions 532a, 533a, 532b, 533b, 532c, 533c, 532d, and 533d and counted value display portions 534a, 534b, 534c, and 534d. Count portions 532a, 533a, 532b, 533b, 532c, 533c, 532d, and 533d are user-selectable buttons for counting the number of the vehicles V running in measurement area 300. Counted value display portion 534a, 534b, 534c, 534d displays a numerical value based on the number of times the user has selected count portion 532a, 533a, 532b, 533b, 532c, 533c, 532d, 533d. Accordingly, when the user selects count portion 532a, 533a, 532b, 533b, 532c, 533c, 532d, or 533d, the number of vehicles can be counted, and the counting result is displayed on counted value display portion 534a, 534b, 534c, or 534d. The user can confirm the detection accuracy of radar 100 by comparing the number of vehicles displayed on first count result display portion 531 with the number of vehicles displayed on counted value display portions 534a, 534b, 534c, and 534d.

First count result display portion 531 may be configured to, if measurement area 300 includes a plurality of lanes, display the number of the vehicles detected by radar 100 during the detection period in association with each of the plurality of lanes included in measurement area 300. The second result display portion may be configured to display, for each of the lanes, count portions 532a, 533a, 532b, 533b, 532c, 533c, 532d, and 533d and counted value display portions 534a, 534b, 534c, and 534d in correspondence with each other. Accordingly, the user can compare the number of vehicles detected by radar 100 with the counted value for each of the lanes.

The different means may detect the number of the vehicles in the detection period. Setting screen 500 may further include collation result display portion 550. Collation result display portion 550 displays a collation result of the number of the vehicles detected during the detection period by radar 100 and the number of the vehicles detected during the detection period by different means. Accordingly, the user can confirm the detection accuracy of radar 100 through the collation result displayed on collation result display portion 550.

Setting screen 500 may further include image display portion 520. Image display portion 520 is configured to display a moving image obtained by camera 107 configured to photograph measurement area 300. Radar setting apparatus 400 may further include record unit 424. Record unit 424 is configured to record setting screen 500 in which the collation result is displayed on collation result display portion 550 and the moving image is displayed on image display portion 520. This can provide evidence that radar 100 is operating properly.

The different means may detect the number of the vehicles in the detection period. Display unit 405 may display the detection accuracy of radar 100 together with time information indicating the detection period. The accuracy is represented by a ratio between the number of the vehicles detected by radar 100 during the detection period and the number of the vehicles detected by different means during the detection period. Accordingly, the user can confirm the detection accuracy of radar 100 together with the time information. For example, by recording setting screen 500 on which accuracy is displayed together with time information, the degree of detection accuracy in the detection period can be confirmed afterward.

The time information may include a date and a time on and at which the detection period ends. Accordingly, the user can confirm the detection accuracy along with the date and time. For example, by recording setting screen 500 on which the accuracy is displayed together with the time information, it is possible to confirm the degree of detection accuracy at which date and time afterward.

### 8. SUPPLEMENTARY NOTES

### Supplementary Note 1

An infrastructure radar for detecting a vehicle in a measurement area, comprising:
a receiving antenna configured to receive a reflected wave reflected by the vehicle of a radio wave irradiated to the measurement area;
a detection unit configured to detect a distance to the vehicle, an angle with respect to the vehicle, and a speed of the vehicle based on the reflected wave received by the receiving antenna;
a housing;
a light emitting unit disposed in the housing; and
a control unit configured to control light emission and non-light emission of the light emitting unit based on a detection result by the detection unit.

### Supplementary Note 2

An infrastructure radar for detecting a vehicle in a measurement area, comprising:
a receiving antenna configured to receive a reflected wave reflected by the vehicle of a radio wave irradiated to the measurement area;
a detection unit configured to detect a distance to the vehicle based on the reflected wave received by the receiving antenna;
a housing;
a light emitting unit disposed in the housing; and
a control unit configured to cause the light emitting unit to emit light when the distance detected by the detection unit falls within a threshold range associated with the light emitting unit.

### Supplementary Note 3

An infrastructure radar for detecting vehicle in a measurement area, comprising:
a receiving antenna configured to receive a reflected wave reflected by the vehicle of a radio wave irradiated to the measurement area;
a detection unit configured to detect a distance to the vehicle based on the reflected wave received by the receiving antenna;
a housing;
a light emitting unit disposed in the housing and capable of emitting light in a plurality of light emitting modes; and
a control unit configured to control the light emitting unit to emit light in a light emitting mode corresponding to the distance detected by the detection unit.

### Supplementary Note 4

An infrastructure radar for detecting vehicle in a measurement area, comprising:
a receiving antenna configured to receive a reflected wave reflected by the vehicle of a radio wave irradiated to the measurement area;
a detection unit configured to detect a distance to the vehicle based on the reflected wave received by the receiving antenna;
a housing;
a first light emitting unit and a second light emitting unit disposed in the housing;
a control unit configured to control light emission and non-light emission of each of the first light emitting unit and the second light emitting unit based on the distance detected by the detection unit, wherein
the control unit controls the first light emitting unit to emit light when the distance detected by the detection unit falls within a first threshold range, and controls the second light emitting unit to emit light when the distance falls within a second threshold range.

### Supplementary Note 5

An infrastructure radar comprising:
a receiving antenna configured to receive a reflected wave reflected by a vehicle of a radio wave irradiated to a measurement area;
a detection unit configured to detect the vehicle in the measurement area based on the reflected wave received by the receiving antenna;
a housing;
a light emitting unit disposed in the housing; and
a control unit configured to control the light emitting unit to emit light when the number of vehicles detected by the detection unit falls within a threshold range associated with the light emitting unit.

### Supplementary Note 6

An infrastructure radar comprising:
a receiving antenna configured to receive a reflected wave reflected by a vehicle of a radio wave irradiated to a measurement area;
a detection unit configured to detect vehicle in the measurement area based on the reflected wave received by the receiving antenna;
a housing;
a light emitting unit disposed in the housing and capable of emitting light in a plurality of light emitting modes; and
a control unit configured to control the light emitting unit to emit light in a light emitting mode corresponding to the number of vehicles detected by the detection unit.

### Supplementary Note 7

An infrastructure radar comprising;
a receiving antenna configured to receive a reflected wave reflected by a vehicle of a radio wave irradiated to a measurement area;
a detection unit configured to detect the vehicle in the measurement area based on the reflected wave received by the receiving antenna;
a housing;
a first light emitting unit and a second light emitting unit disposed in the housing;
a control unit configured to control light emission and non-light emission of each of the first light emitting unit and the second light emitting unit based on the number of vehicles detected by the detection unit, wherein
the control unit controls the first light emitting unit to emit light when the number of vehicles detected by the detection unit falls within a first threshold range, and controls the second light emitting unit to emit light when the number of vehicles falls within a second threshold range.

### 9. APPENDIX

The embodiments disclosed herein are illustrative in all respects, and are not restrictive. The scope of the present invention is defined not by the above-described embodiments but by the claims, and includes all modifications within the scope and meaning equivalent to the claims.

### REFERENCE SIGNS LIST

0 radar (infrastructure sensor)
101 transceiving surface
102 radar body
103 depression angle adjustment unit
104 horizontal angle adjustment unit
105 roll angle adjustment unit
106 storage unit
107 camera
110A, 110B, 110C, 110D, 110E, 110F LED
111 processor
112 non-volatile memory
113 volatile memory
114 transmitting circuit
115 receiving circuit
117 data processing program
114a transmitting antenna
115a, 115b receiving antenna
121 input unit
122 detection unit
123 determination unit
124 control unit
200 arm
300 target area
400 radar setting apparatus (display apparatus)
401 processor
402 non-volatile memory
403 volatile memory
404 graphic controller
405 display unit
406 input apparatus
409 setting program
411 setting screen display unit
412 image input unit
413 data input unit
414 lane shape input unit
415 mark point input unit
416 lane editing unit
417 coordinate adjustment unit
418 setting information transmitting unit
419 trajectory data receiving unit
420 first count result input unit
421 second count result input unit
422 radar detection result receiving unit
423 collation unit
424 record unit
500 setting screen (confirmation screen)
510 user operation portion
511 image reading instruction portion
511a image reading button
512 basic data input portion
512a number-of-lanes input portion
512b lane width input portion
512c installment height input portion
512d offset amount input portion
512e detection method input portion
513 lane drawing instruction portion
513a lane drawing instruction button
513b lane editing button
514 mark point input instruction portion
514a mark point input button
514b coordinate input portion
515 lane adjustment portion
515a enlarge button
515b reduce button
515c move up button
515d move down button
515e move right button
515f move left button
515g clockwise button
515h counterclockwise button
515i front rotation button
515j back rotation button
520 image display portion
521 camera image
522,523 lane shape line
523a, 523b mark point
523c node
524 running trajectory
530 traffic count result display portion
531 first count result display portion (first result display portion)
531a, 531b, 531c, 531d, 534a, 534b, 534c, 534d counted value display portion
532 second count result display portion (second result display portion)
532a, 533a, 532b, 533b, 532c, 533c, 532d, 533d count portion
535 detection period display portion
535a receiving time display portion
535b scheduled receiving time display portion
535c receiving interval display portion
536 clear button
540 bird's eye view display portion
541 bird's eye view
542 FIG.
550 collation result display portion
550a accuracy display portion
550b determination result display portion
551 log start button
560 save instruction portion
561 save instruction button
562 cancel button
600 select portion
610 manual input button
620 automatic input button
630 radar input button
R1, R2, R3 lane region
V vehicle

1. A display apparatus comprising:
a first result display portion configured to display a first traffic volume detected by an infrastructure sensor configured to detect vehicles in a measurement area; and
a second result display portion configured to display reference information indicating a second traffic volume obtained by a means different from the infrastructure sensor during a same period as a period during which the infrastructure sensor detects the first traffic volume.

2. The display apparatus according to claim 1, wherein
an image obtained by a camera configured to photograph the measurement area during the period is displayed.

3. The display apparatus according to claim 2, further comprising
collation circuitry configured to collate the first traffic volume with the second traffic volume recognized by subjecting the image to an image recognition process.

4. The display apparatus according to claim 1, wherein
the second traffic volume is a number of the vehicles having passed a specific spot in the measurement area during the period, the number being input by a user.

5. The display apparatus according to claim 4, wherein
the second result display portion comprises:
a count portion configured to receive an operation by the user for counting the number of the vehicles having passed the specific spot; and
a counted value display portion configured to display the number of the vehicles having passed the specific spot, based on the operation by the user on the count portion.

6. The display apparatus according to claim 5, wherein
the first result display portion is configured to, if the measurement area includes a plurality of lanes, display, for each of the lanes, the first traffic volume detected by the infrastructure sensor during the period, and
the second result display portion is configured to display, for each of the lanes, the count portion and the counted value display portion in correspondence with each other.

7. The display apparatus according to claim 1, further comprising
a collation result display portion configured to display a collation result between the first traffic volume and the second traffic volume.

8. The display apparatus according to claim 1, further comprising
record circuitry configured to record a screen on which a collation result between the first traffic volume and the second traffic volume and a moving image obtained by a camera configured to photograph the measurement area during the period are displayed.

9. The display apparatus according to claim 1, wherein
accuracy of detection by the infrastructure sensor, the accuracy being calculated based on a ratio between the first traffic volume and the second traffic volume, and time information indicating the period are displayed.

10. The display apparatus according to claim 9, wherein
the time information includes a date and a time on and at which the period ends.

11. A non-transitory computer-readable storage medium storing a computer program for causing a computer to execute:
a process of displaying, on a display apparatus, a first traffic volume of vehicles detected by an infrastructure sensor configured to detect the vehicles in a measurement area; and
a process of displaying, on the display apparatus, reference information indicating a second traffic volume obtained by a means different from the infrastructure sensor during a same period as a period during which the infrastructure sensor detects the first traffic volume.

12. The non-transitory computer-readable storage medium storing a computer program according to claim 11, for causing the computer to execute
a process of displaying, on the display apparatus, an image obtained by a camera configured to photograph the measurement area during the period.

13. The non-transitory computer-readable storage medium storing a computer program according to claim 12, for causing the computer to execute
a process of collating the first traffic volume with the second traffic volume recognized by subjecting the image to an image recognition process.

14. The non-transitory computer-readable storage medium storing a computer program according to claim 11, wherein
the second traffic volume is a number of the vehicles having passed a specific spot in the measurement area during the period, the number being input by a user.

15. The non-transitory computer-readable storage medium storing a computer program according to claim 14, for causing the computer to execute:
a process of displaying, on the display apparatus, a count portion configured to receive an operation by the user for counting the number of the vehicles having passed the specific spot; and
a process of displaying, on the display apparatus, the number of the vehicles having passed the specific spot, based on the operation by the user on the count portion.

16. The non-transitory computer-readable storage medium storing a computer program according to claim 15, for causing the computer to execute
if the measurement area includes a plurality of lanes, a process of displaying, on the display apparatus, for each of the lanes, the first traffic volume detected by the infrastructure sensor during the period, and displaying, on the display apparatus, for each of the lanes, the count portion and the counted value display portion in correspondence with each other.

17. The non-transitory computer-readable storage medium storing a computer program according to claim 11, for causing the computer to execute
a process of displaying, on the display apparatus, a collation result between the first traffic volume and the second traffic volume.

18. The non-transitory computer-readable storage medium storing a computer program according to claim 17, wherein
the reference information is a moving image obtained by a camera configured to photograph the measurement area, the computer program causing the computer to further execute
a process of recording a screen on which the collation result and the moving image are displayed.

19. The non-transitory computer-readable storage medium storing a computer program according to claim 11, for causing the computer to execute
a process of displaying, on the display apparatus, accuracy of detection by the infrastructure sensor, the accuracy being calculated based on a ratio between the first traffic volume and the second traffic volume, and time information indicating the period.

20. The non-transitory computer-readable storage medium storing a computer program according to claim 19, wherein
the time information includes a date and a time on and at which the period ends.
